(19) United States
(12) Patent Application Publication
(10) Pub. No.: US 2008/0058977 A1
(43) Pub. Date: Mar. 6, 2008

(54) REVIEWING APPARATUS USING A SEM AND METHOD FOR REVIEWING DEFECTS OR DETECTING DEFECTS USING THE REVIEWING APPARATUS

(76) Inventor: Toshifumi Honda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/779,937

(22) Filed: Jul. 19, 2007

(30) Foreign Application Priority Data
Aug. 7, 2006 (JP) 2006-214499

(51) Int. Cl. G06F 19/00

(52) U.S. Cl. 700/110

(57) ABSTRACT

A reviewing apparatus using a SEM and a method for reviewing defect according to the present invention includes the steps of: correcting alignment errors of coordinates of the large number of defect candidates output by the inspection apparatus; selecting a detailed inspection/review point on the basis of the distance between coordinates of each of the large number of defect candidates whose alignment errors have been corrected and a point of interest such as a hot spot; performing imaging by use of a detailed inspection apparatus to acquire an image at the position, and to acquire an image in proximity to the position; determining, from the acquired image, a detailed coordinate position of the defect detected by inspection apparatus; and on the basis of the acquired image and detailed defect coordinate position, judging whether or not the selected defect is a defect that is important for the process control.

### BACKGROUND OF THE INVENTION

The present invention relates to a scanning electron microscope (hereinafter referred to as “SEM”) that irradiates an industrial product (in particular, a semiconductor in course of manufacturing in an upstream semiconductor process) with a focused electron beam, and that then detects an electron emitted from the irradiated position to image a target to be reviewed to acquire an image thereof. In particular, the present invention relates to a defect reviewing method and a defect inspection method, both of which use a SEM-based reviewing apparatus and a SEM-based reviewing apparatus that review in more detail a defect detected on a semiconductor wafer by a SEM-based semiconductor wafer inspection apparatus, the defect being required to be imaged at high magnification, and that perform more detailed inspection on the basis of the defect output from the inspection apparatus.

With the miniaturization of semiconductors, the control of an upstream manufacturing process of semiconductors is becoming more and more difficult. In an exposure process of semiconductors, the difference between the design pattern size and a pattern image transferred to photoresist, which is caused by a light beam proximity effect, cannot be ignored. For this reason, the optical proximity correction (OPC) for simulating the light beam proximity effect to correct a mask pattern is performed. In addition, in an exposure process that uses a mask, to which OPC is applied, fluctuations in process cause a spot in which a failure relatively easily occurs (that is to say, a hot spot). Therefore, mask layout design is often changed so that manufacturing is normally performed also in such a hot spot even if the manufacturing is influenced by the process fluctuations to some extent. Thus, a designing technique which is carried out so as to suppress the occurrence of a failure in an exposure process is coming to be known as “design for manufacturing (DFM)”. In order to efficiently carry out the design for manufacturing, what is earnestly desired is such a system that a state of manufacturing is smoothly fed back to design.

As one of the techniques used to achieve the above, for example, JP-A-2002-33365 (patent document 1) discloses a wafer pattern reviewing method comprising the steps of: determining a plurality of management points by analyzing CAD (Computer Aided Design) data; acquiring a group of review coordinate data in accordance with the plurality of determined management points; performing alignment navigation with reference to the group of review coordinate data; and successively reviewing the plurality of determined management points of a wafer pattern.

In addition, JP-A-10-135288 (patent document 2) discloses a parts inspection system including: an inspected-parts information database for storing: preliminary inspection information including positional information, and size information, on defects existing in inspected parts; and review information acquired by review that is detailed inspection using a reviewing apparatus for detailed inspection of the inspected parts; type determination information input means for inputting type determination information on the inspected parts assigned to an inspected-parts holding member; preliminary inspection information reading means for reading, from the inspected-parts information database, the preliminary inspection information on inspected parts corresponding to the type determination information, which is inputted by the type determination information input means; and review information registering means for storing, in the inspected-parts information database, review information acquired by review relating to review selected from among defects included in the read preliminary inspection information.

However, even if the above-described conventional technique is used, it is becoming difficult to correctly monitor a state in which semiconductor wafers are manufactured. In the case of the method for automatically determining a point at which a manufacturing state is analyzed by CAD data, which is the first conventional technique described in the patent document 1, because the density of semiconductor patterns is becoming higher, and because the size of semiconductor wafers is becoming larger from 200 mm to 300 mm, the number of management points to be evaluated excessively increases, which makes it impossible to manage all management points. Because of it, wafers to be evaluated, and chips to be evaluated, are sampled to reduce the number of evaluation points. However, a method for achieving maximum effects from the minimum number of sampling points is not yet established.

In addition, information about manufacturing, which is important for DFM, requires that an assumption at the time of design for lithography simulation coincides with the result acquired by inspection and measurement at the time of actual manufacturing. Accordingly, only by reviewing defects, such as foreign materials, which do not closely relate to design, it is difficult to feed back the result of the review to the design. Information, which is important for feedback to the design, is obtained from defects including thinned and thickened patterns, and a reduced diameter of a contact hole. However, in the case of generally used wafer visual inspection apparatuses, a defect, which cannot be detected unless the sensitivity of defect detection is extremely increased, becomes a defect of interest (DOI). On the other hand, if the sensitivity of an inspection apparatus is extremely increased, for example, a grain on the top surface of a wiring pattern, which is not a defect, is detected, and the difference in film thickness between dies to be compared is detected. In other words, a large number of non-DOI defects are detected. As a result, it is not possible to properly manage a manufacturing state, which was the problem to be solved.

Moreover, recently the design rule of semiconductor patterns requires about 55 nm at a minute point; and in the next several years, the design rule will require about 32 nm. In contrast to this, the accuracy of coordinates detected by optical inspection apparatuses is in general several micrometers or more. Even in the case of SEM-based reviewing apparatuses and length measuring SEMs, the accuracy of movement of a stage for moving a wafer is about 1 micrometer. Because the pattern size is small with respect to the accuracy of coordinates, it is impossible to make a DOI judgment on the basis of a defect coordinate position.

### SUMMARY OF THE INVENTION

An object of the present invention is to provide a SEM-based reviewing apparatus, and a defect reviewing method and a defect inspection method, both of which use the SEM-based reviewing apparatus. The SEM-based reviewing apparatus is capable of managing a manufacturing state of semiconductor wafers, which is adapted to the miniaturization of patterns, by efficiently narrowing down points to be subjected to detailed inspection/review from among a large number of defect candidates detected by an inspection apparatus, and by determining, with high accuracy, coordinates of the points that have been subjected to the detailed inspection/review.

The present invention has been made to achieve the above-described object. According to one aspect of the present invention, attention is paid to the fact that when a SEM-based reviewing apparatus performs detailed inspection/review of a large number of defect candidates detected by an inspection apparatus, an offset error often occurs in the coordinate accuracy of the inspection apparatus. Accordingly, the SEM-based reviewing apparatus performs realignment with offset errors which overlap coordinates of the inspection apparatus being excluded. Then, the SEM-based reviewing apparatus uses CAD data to select a defect whose possibility of having occurred in a point to be managed is high, such as a hot spot expected by for example lithography simulation, and performs detailed inspection/review of the defect so that information which can be fed back to design is acquired.

According to another aspect of the present invention, there is provided a method for reviewing defects by use of a reviewing apparatus equipped with a SEM, the method comprising the steps of:

inputting positional information of plural defect candidates on a semiconductor wafer, which have been acquired by inspecting the semiconductor wafer with an inspection apparatus, and inputting CAD data of patterns formed on the semiconductor wafer;

calculating positional information on the inputted CAD data of the patterns corresponding to the inputted positional information of the plural defect candidates on the semiconductor wafer;

selecting defects to be subjected to detailed inspection or review by use of the reviewing apparatus equipped with the SEM on the basis of the calculated positional information on the plural defect candidates on the CAD data; and

performing the detailed inspection or review of the selected defects by use of the reviewing apparatus equipped with the SEM.

According to still another aspect of the present invention, there is provided a method for reviewing defects by use of a reviewing apparatus equipped with a SEM, the method comprising the steps of:

calculating an alignment coordinate system by calculating a position on a semiconductor wafer on the basis of positional information on an alignment pattern acquired from CAD data;

calculating positions of selected defect candidates in the alignment coordinate system that has been calculated by processing an image acquired by imaging with the SEM about the selected defect candidates selected from among plural defect candidates whose positional information on the semiconductor wafer are known;

calculating relationship of error between the positional information of the selected defect candidates on the semiconductor wafer and the calculated positions of the selected defect candidates in the calculated alignment coordinate system;

correcting the positional information of the plural defect candidates whose positional information on the semiconductor wafer are known, on the basis of the calculated relationship of the error;

selecting defect candidates to be subjected to detailed inspection or review on the basis of the corrected positional information of the plural defect candidates on the semiconductor wafer; and

performing the detailed inspection or review of the selected defect candidates.

According to a further aspect of the present invention, there is provided a method for reviewing defects by use of a reviewing apparatus equipped with a SEM, the method comprising the steps of:

inputting positional information of plural defect candidates on a semiconductor wafer, which are acquired by inspecting the semiconductor wafer by use of an inspection apparatus, and inputting a detailed inspection point candidate on the semiconductor wafer;

analyzing a distribution pattern of defects on the semiconductor wafer on the basis of the positional information of the inputted plural defect candidates on the semiconductor wafer;

determining a detailed inspection point on the semiconductor wafer on the basis of the inputted detailed inspection point candidate on the semiconductor wafer, and the distribution pattern of the defects on the semiconductor wafer, which is acquired in the step of analyzing the distribution pattern of the defects;

acquiring a SEM image of the detailed inspection point by setting a visual field of the SEM with respect to the determined detailed inspection point on the semiconductor wafer; and

inspecting the detailed inspection point by processing the acquired SEM image.

According to still a further aspect of the present invention, there is provided a reviewing apparatus equipped with a SEM, the reviewing apparatus comprising:

an input unit which inputs positional information of plural defect candidates on a semiconductor wafer, which have been acquired by inspecting the semiconductor wafer by an inspection apparatus, and inputs CAD data of patterns formed on the semiconductor wafer;

a defect candidate position calculation unit which calculates positional information on the inputted CAD data corresponding to the inputted positional information of the plural defect candidates on the semiconductor wafer, which have been inputted by the input units;

a defect selection unit which selects a defect candidate to be subjected to detailed inspection or review on the basis of the positional information of the plural defect candidates on the CAD data calculated by the defect candidate position calculation unit; and

a SEM image acquiring unit which acquires a SEM image of the selected defect candidate by imaging the defect candidate selected by the defect selection unit.

According to yet another aspect of the present invention, there is provided a reviewing apparatus equipped with a SEM, the reviewing apparatus comprising:

a SEM image acquiring unit which acquires a SEM image of a sample by irradiating the sample with a focused electron beam to scan the sample, and by detecting a secondary electron or a backscattered electron, which is emitted from the sample;

an alignment coordinate system calculation unit which calculates an alignment coordinate system by calculating a position on a semiconductor wafer on the basis of positional information on an alignment pattern acquired from CAD data;

a position calculation unit which calculates positions of selected defect candidates in the calculated alignment coordinate system by processing an image acquired by imaging with the SEM image acquiring unit about the selected defect candidates selected from among plural defect candidates whose positional information on the semiconductor wafer are known;

an error calculation unit which calculates relationship of error between the positional information on the selected defect candidate on the semiconductor wafer and the calculated positions of the selected defect candidates in the calculated alignment coordinate system;

a defect position information correction unit which corrects the positional information of the plural defect candidates whose positional information on the semiconductor wafer are known, on the basis of the calculated relationship of the error calculated by the error calculation unit;

a defect selection unit which selects defect candidates to be subjected to detailed inspection or review on the basis of the corrected positional information of the plural defect candidates on the semiconductor wafer corrected by the defect positional information correction unit; and

an image processing unit which performs the detailed inspection or review of the selected defect candidates by processing the SEM image that has been acquired by the SEM image acquiring unit.

According to yet still another aspect of the present invention, there is provided a reviewing apparatus equipped with a SEM, the reviewing apparatus comprising:

a SEM image acquiring unit which acquires a SEM image of a sample by irradiating the sample with a focused electron beam to scan the sample, and by detecting a secondary electron or a backscattered electron, which is emitted from the sample;

an input unit which inputs positional information of plural defect candidates on a semiconductor wafer, which are acquired by inspecting the semiconductor wafer by use of an inspection apparatus, and inputs a detailed inspection point candidate on the semiconductor wafer;

a distribution pattern analyzing unit which analyzes a distribution pattern of defects on the semiconductor wafer on the basis of the positional information of the inputted plural defect candidates on the semiconductor wafer inputted by the input unit;

a detailed inspection point determination unit which determines a detailed inspection point on the semiconductor wafer on the basis of the inputted detailed inspection point candidate on the semiconductor wafer inputted by the input unit and the distribution pattern of the defects on the semiconductor wafer analyzed by the distribution pattern analyzing unit;

a SEM image visual field setting unit which acquires a SEM image of the detailed inspection point by setting a visual field of the SEM image acquiring unit with respect to the determined detailed inspection point on the semiconductor wafer determined by the detailed inspection point determination unit; and

an image processing unit which inspects the detailed inspection point by processing the SEM image acquired with the visual field set by the SEM image visual field setting unit.

According to the present invention, defects, which are important for the process management adapted to the miniaturization of patterns, can be automatically extracted from a large number of defect candidates output from an inspection apparatus so that detailed inspection or review can be carried out by a SEM-based reviewing apparatus, or the like.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a diagram illustrating a basic configuration of a SEM-based reviewing apparatus that performs detailed inspection/review of defects;

FIG. 2 is a diagram illustrating one embodiment of a system configuration in which data is inputted into an apparatus for performing detailed inspection/review;

FIG. 3 is a diagram illustrating another embodiment of a system configuration in which data is inputted into an apparatus for performing detailed inspection/review;

FIG. 4 is a diagram illustrating a method for selecting (sampling) defects to be subjected to detailed inspection/review in a reviewing apparatus (including a defect server);

FIG. 5 is a diagram schematically illustrating an alignment pattern that is formed on a wafer on an exposure basis;

FIG. 6 is a diagram illustrating the relationship between a CAD coordinate system on a wafer with reference to an alignment pattern (an alignment coordinate system x-y) and a coordinate system x′-y′ of an inspection apparatus;

FIG. 7 is diagram illustrating an alignment error between the CAD coordinate system on the wafer with reference to an alignment pattern (alignment coordinate system x-y) and the coordinate system x′-y′ of the inspection apparatus;

FIG. 8 is a chart illustrating a first embodiment of a sequence of automatically performing detailed inspection/review of defects in a reviewing apparatus;

FIG. 9 is a chart specifically illustrating one embodiment of a defect imaging sequence in a step S82 shown in FIG. 8;

FIG. 10 is a chart illustrating a second embodiment of a sequence of automatically performing detailed inspection/review of defects in a reviewing apparatus;

FIG. 11 is a diagram illustrating a first embodiment of a method for selecting a detailed inspection/review point, which corresponds to a third embodiment of a sequence of automatically performing detailed inspection/review of defects in a reviewing apparatus;

FIG. 12 is a diagram illustrating a second embodiment of a method for selecting a detailed inspection/review point, which corresponds to the third embodiment of a sequence of automatically performing detailed inspection/review of defects in the reviewing apparatus;

FIG. 13 is a diagram illustrating a third embodiment of a method for selecting a detailed inspection/review point, which corresponds to the third embodiment of a sequence of automatically performing detailed inspection/review of defects in the reviewing apparatus;

FIG. 14 is a diagram illustrating one embodiment of GUI for inputting an area to be subjected to detailed inspection/review;

FIG. 15 is a diagram illustrating a fourth embodiment of a method for selecting a detailed inspection/review point, which corresponds to the third embodiment of a sequence of automatically performing detailed inspection/review of defects in the reviewing apparatus;

FIG. 16 is a chart illustrating one embodiment of a detailed defect inspection sequence;

FIG. 17 is a diagram illustrating a detailed inspection method;

FIG. 18A is a diagram illustrating an image acquired by reviewing an area including a defect candidate 902 by use of a SEM; FIG. 18B is a diagram illustrating a detailed calculation method for calculating a defect position according to a fourth embodiment, and illustrating a unique image having an aperiodic pattern by use of an enlarged image including the defect candidate 902 shown in FIG. 18A; FIG. 18C is a diagram illustrating a detailed calculation method for calculating a defect position according to the fourth embodiment, and illustrating a unique image having an aperiodic pattern, the unique image being acquired by performing imaging with a visual field being moved at the same magnification as that in FIG. 18A;

FIG. 19 is a chart illustrating one embodiment of a defect imaging sequence, which corresponds to a fourth embodiment of a sequence of automatically performing detailed inspection/review of defects in a reviewing apparatus;

FIG. 20 is a chart illustrating another embodiment of a defect imaging sequence that is improved from the defect imaging sequence shown in FIG. 19;

FIG. 21 is a diagram illustrating a detailed inspection method; and

FIG. 22 is a conceptual diagram illustrating an automatic defect classification method.

### DESCRIPTION OF THE PREFERRED EMBODIMENTS

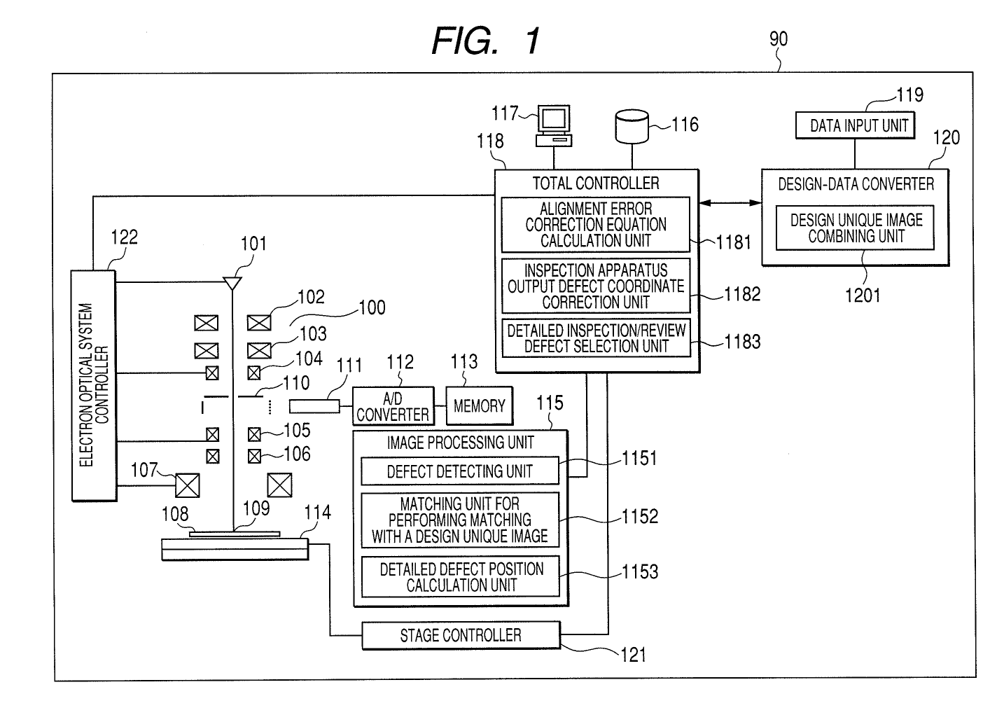

Methods for detecting and reviewing defects on a semiconductor wafer, and an apparatus thereof, according to embodiments of the present invention, will be described with reference to FIGS. 1 through 22.

A pattern of a semiconductor wafer is formed in a multilayer structure through a large number of processes. In the processes of manufacturing this multilayer structure, in order to monitor the manufacturing processes, measurement of the size of the pattern formed on a layer basis, and visual inspection of the pattern, are performed. Further, defects detected in the visual inspection are reviewed.

Recently, semiconductor processes are getting more and more miniaturized. Therefore, SEM, which is capable of imaging with higher resolution than that of optical microscopes, is more often applied to imaging used for the semiconductor processes. As SEM that is used for such a purpose, review SEM is achieving widespread use. Main functions of a SEM-based reviewing apparatus 90 is to move a visual field to a position of a defect on the basis of defect coordinates detected as a result of visual inspection, and to image this defect by use of a SEM.

FIG. 1 is a diagram illustrating a basic configuration when the present invention is applied to the SEM-based reviewing apparatus. To be more specific, the reference numeral 90 denotes a whole of apparatus for performing detailed inspection/review being composed with, for example, a review SEM, a CD-SEM, or the like. The SEM-based reviewing apparatus 90 is an apparatus that inputs, from a data input unit 119, wafer information, and coordinates of a defect detected by another inspection apparatus, and that images the defect on a wafer by use of a SEM with high magnification to review the defect.

A review SEM microscope 100 includes: an electron beam source 101 for emitting an electron beam; condenser lenses 102, 103, each of which focuses the emitted electron beam; an electron beam axis aligner 104 for correcting astigmatism and deviation in alignment; scanning units (deflector) 105, 106, each of which deflects the electron beam; an objective lens 107 for focusing the electron beam; a reflecting plate (E×B) 110 having a hole through which a primary electron beam passes; and an electron detector 111 for detecting a secondary electron occurred on the reflecting plate 110 and a backscattered electron therefrom. Next, an electron optical system controller 122 is configured to control the electron beam source 101, the electron beam axis aligner 104, the scanning units 105, 106, the objective lens 107, and the like, on the basis of an instruction received from a total controller 118.

To be more specific, the electron beam emitted from the electron beam source 101 passes through the condenser lenses 102, 103. Then, the electron beam axis aligner 104 corrects the astigmatism and the deviation in alignment. Further, the scanning units 105, 106 deflect the electron beam at low magnification or at high magnification to control an irradiation position thereof. After that, the objective lens 107 focuses the electron beam so that an imaging target 109 of a wafer 108 is irradiated with the electron beam. As a result, a secondary electron and a backscattered electron are emitted from the imaging target 109. The secondary electron and the backscattered electron collide with the reflecting plate 110 having a hole through which the primary electron beam passes, and consequently a secondary electron is generated there. The electron detector 111 detects the generated secondary electron.

The secondary electron and the backscattered electron, which have been detected by the electron detector 111, are converted into digital signals at low magnification or at high magnification by an A/D converter 112. The digital signals are then stored in a memory 113 so that the digital signals are reviewed at low magnification or at high magnification. Moreover, an XY stage 114, which is controlled by a stage controller 121 on the basis of an instruction received from the total controller 118, moves the imaging target (wafer) 108. This makes it possible to image the wafer at an arbitrary position. An image processing unit 115 is configured to have a CPU that functionally includes a defect detecting unit 1151. The defect detecting unit 1151 compares an electron-beam image (SEM image) of a defect position, which is stored in the memory 113, with for example a reference electron-beam image (reference SEM image) in which the same pattern as that of the electron-beam image is expected to be formed, and thereby detects, as a defect position, a position at which there is a difference between both of the images.

Further, the CPU forming the image processing unit 115 functionally includes: a matching unit 1152 for performing matching with a design unique image, more specifically, for matching a defect image with high magnification, which is acquired at a position of a selected defect, with a design unique image included in CAD data converted by a design-data converter 120, which will be specifically described later; and a detailed defect position calculation unit 1153 for identifying a position of the selected defect with respect to the CAD data on the basis of the result of the matching with the design unique image.

A storage device 116 and a computer terminal 117 are connected to the total controller 118. The computer terminal 117 includes a display unit and input means. The total controller 118 instructs the electron optical system controller 122 to adjust an electron beam axis by use of the electron beam axis aligner 104, and to control the deflection of an electron beam by use of the scanning units 105, 106. In addition, the total controller 118 instructs the stage controller 121 to control the movement of a visual field by use of the XY stage 114. Moreover, the total controller 118 is configured to have a CPU that functionally includes: an alignment error correction equation calculation unit 1181 for calculating the relationship of the alignment error correction equation, which will be specifically described later; an inspection apparatus output defect coordinate correction unit 1182 for correcting defect coordinates output from an inspection apparatus on the basis of the relationship of the alignment error correction equation; and a detailed inspection/review defect selection unit 1183 for selecting a detailed inspection/review defect candidate (a defect candidate to be reviewed) on the basis of the positional relationship between a viewpoint on CAD data and the corrected defect coordinates output from the inspection apparatus.

Here, the storage device 116 is capable of memorizing an image stored in the memory 113, and what is more, is capable of storing, for example, a defect position, and characteristic appearance of a defect, which are acquired by image processing.

On the other hand, the computer terminal 117 including the display unit is capable of displaying an image stored in the storage device 116 or the memory 113. In addition, a user can set review conditions including various kinds of information about operation of a reviewing apparatus, and imaging magnification thereof, by inputting them into the computer terminal 117.

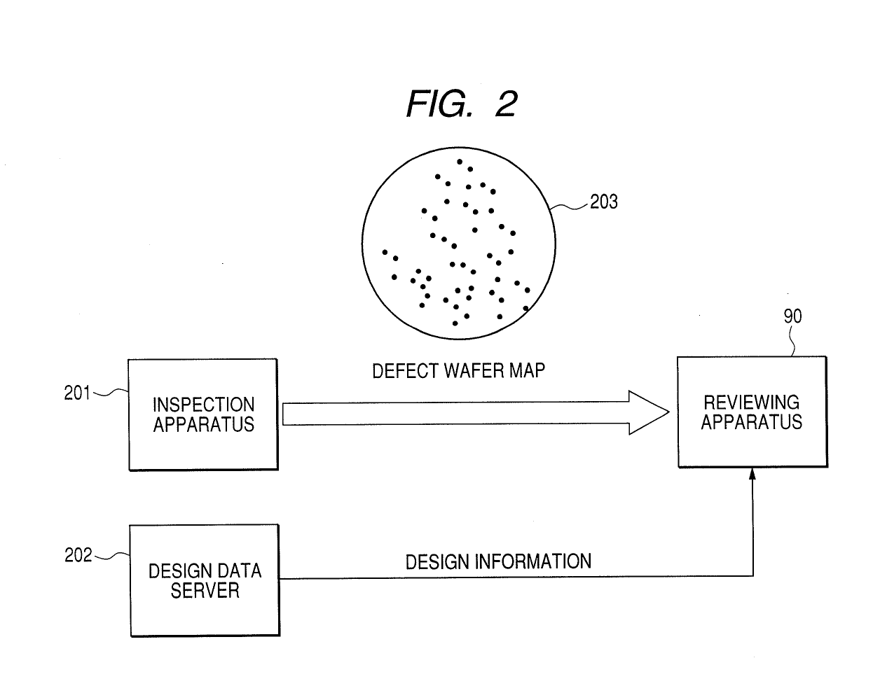

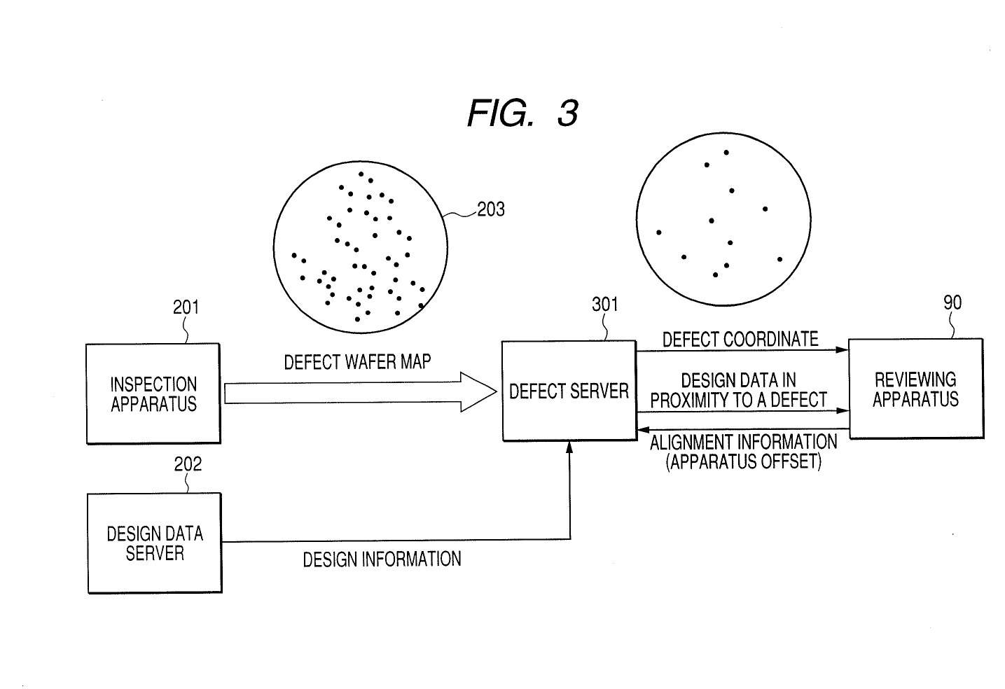

Next, the data input unit 119 is formed with a network, or the like. The data input unit 119 is configured to be capable of inputting defect coordinate data output from an inspection apparatus 201, CAD data of a unique pattern in proximity to defect coordinates, CAD data of an alignment pattern, and the like, from for example a design data server (CAD system) 202, which is shown in FIGS. 2 and 3. A design unique image combining unit 1201 of the design-data converter 120 converts stroke data into CAD image data (design unique image data) on the basis of defect coordinates with reference to an alignment pattern inputted from the total controller 118 so that CAD data in proximity to the defect can be easily matched with a SEM image of the defect. The image processing unit 115 can also calculate a detailed defect position on a wafer on the basis of a CAD image by matching the CAD image data (design unique image data) converted by the design-data converter 120 with, for example, a high-magnification defect image (having a high resolution of about ±10 nm achieved by the control of the scanning unit 105, 106), which is stored in the memory 113.

First of all, one embodiment of how to input data into a reviewing apparatus (a second inspection apparatus) 90 will be described with reference to FIG. 2. Reference numeral 201 denotes an inspection apparatus for inspecting a semiconductor wafer. In general, the inspection apparatus 201 is equipped with an optical microscope or a SEM so that a surface of a wafer can be reviewed at lower magnification than that of a reviewing apparatus. Accordingly, the inspection apparatus 201 detects minute defects on the surface of the wafer. Incidentally, reference numeral 203 denotes coordinates of a defect in a coordinate system of the inspection apparatus, the defect having been detected by the inspection apparatus 201. The wafer inspected by the inspection apparatus 201 is inspected/reviewed in detail by the reviewing apparatus 90. At this time, coordinate data of a defect in the coordinate system of the inspection apparatus is inputted into the reviewing apparatus 90, the defect having been detected through the inspection of the inspection apparatus 201.

On the other hand, design data of an inspected wafer (for example, position-of-interest group data 401 on design data (CAD coordinate system), such as a predetermined hot spot; and position data of an alignment pattern formed on a wafer on an exposure basis), which is stored in the design data server 202, is also sent to the reviewing apparatus 90. A large number of defects, each of which includes an error of a stage system, and an alignment error, are inputted into the reviewing apparatus 90 from the inspection apparatus 201. From among the large number of defects, the reviewing apparatus 90 selects defect candidates, the number of which is about 50 through 200, and then performs detailed inspection/review of the selected defect candidates, which will be described later.

Next, another embodiment of how to input data into the reviewing apparatus 90 will be described with reference to FIG. 3. First of all, coordinate data of a defect in the coordinate system of the inspection apparatus is transmitted to the defect server 301, the defect having been detected by the inspection apparatus 201. In addition, design data of an inspected wafer (as described below, for example, position-of-interest data on design data (CAD coordinate system on the wafer), such as a predetermined hot spot; and position data of an alignment pattern formed on the wafer on an exposure basis) is transmitted from the design data server 202 to the defect server 301.

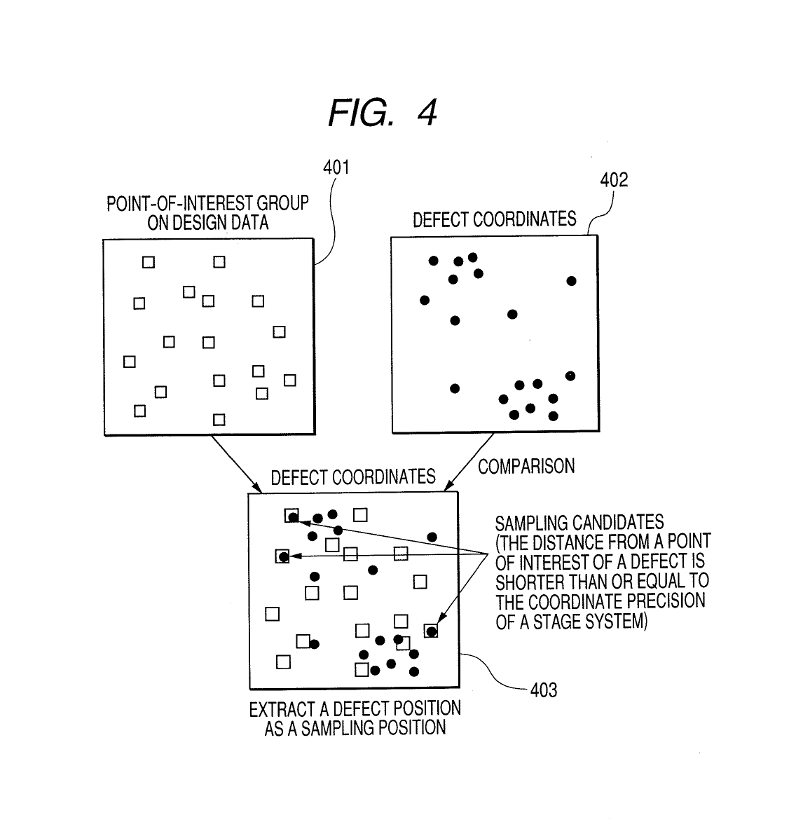

As a result, as specifically described below, the defect server 301 uses alignment information (alignment error correction information) obtained from the reviewing apparatus 90 to perform alignment error correction of a large number of pieces of defect coordinate data obtained from the inspection apparatus. Next, as shown in FIG. 4, the defect server 301 compares the large number of pieces of defect correction coordinate data, which have been subjected to the alignment error correction, with data of a position of interest on design data, such as a hot spot, and thereby selects data which substantially coincide with each other as a defect candidate that is to be subjected to detailed inspection/review. Then, the defect server 301 transmits to the reviewing apparatus 90 the defect correction coordinate data, and design data in proximity to the defect correction coordinate data (design data of an aperiodic unique pattern), corresponding to the selected defect candidate. Thus, the reviewing apparatus 90 can acquire, from the defect server 301, information about a defect candidate that is to be subjected to detailed inspection/review. This enables the reviewing apparatus 90 to perform the detailed inspection/review of the defect candidate.

As described above, in the embodiment shown in FIG. 2, the reviewing apparatus 90 selects a defect candidate to be subjected to detailed inspection/review (in the embodiment shown in FIG. 3, the review server (defect server) 301 selects a defect candidate to be subjected to detailed inspection/review). Then, the detailed inspection/review of the defect candidate selected by the reviewing apparatus 90 is performed.

Next, the reviewing apparatus 90 or the defect server 301, and a method for selecting by the reviewing apparatus 90 a defect candidate to be subjected to detailed inspection/review will be described. Recently, the size of a minute pattern on a chip becomes almost the same as the exposure wavelength. Therefore, a correction technique for correcting a mask pattern in consideration of a proximity effect of a light beam (OPC: Optical Proximity Correction) becomes indispensable. To be more specific, it is necessary to add a correction pattern to, for example, a pattern corner on a mask pattern in consideration of diffraction phenomenon of a light beam. In such a mask pattern, even if the same pattern pitch is used, a spot in which a defect will easily occur, and a spot in which a defect will hardly occur, are generated in response to process fluctuations. Such a spot in which a defect will easily occur is called a “hot spot”. Lithography simulation, or the like, makes it possible to identify on CAD a position that is easily influenced by process fluctuations.

Incidentally, in the case of mask pattern design, it is necessary to change the design so that the number of hot spots becomes smaller. However, at the time of changing the design, it is necessary to evaluate whether or not there is a gap between an assumption at the time of the design by the lithography simulation, or the like, and the actuality. For this reason, in order to achieve the above, it is important to selectively inspect a pattern corresponding to this hot spot, and to manage a manufacturing state.

On the contrary, with the miniaturization of the pattern pitch, a margin of process conditions required to form a normal pattern becomes smaller. As a result of it, the number of hot spots to be managed increases to a large extent.

In general, when this hot spot is managed, a high-magnification image is acquired by use of a SEM, and then inspection including the measurement of the width between patterns is performed. However, in order to shorten a length of time required for this inspection, sampling inspection is indispensable. In the sampling inspection, part of hot spots, the number of which is increasing, is selected, and then images of the selected hot spots are acquired. As a sampling method for sampling the hot spots, it is thought that the hot spots are sampled so that the density of sampling points on a wafer simply becomes relatively uniform. However, if this method is adopted, there may also occur a case where it is not possible to image an image of a hot spot in which a defect has occurred.

In addition, in order to perform detailed inspection/review of only a hot spot that certainly includes a defect, there is considered a method in which the whole surface of a wafer is inspected by use of an optical or SEM inspection apparatus, and then only a defective part is inspected by use of a reviewing apparatus capable of acquiring an image with higher magnification. However, if this method is adopted, there is a high possibility that a defect, which does not cause a failure in properties to which attention should be paid, will be inspected. Moreover, if the sensitivity of the inspection apparatus is set at a high value, about a few thousand defects may often be detected from one wafer. Therefore, it is realistically impossible to carry out detailed inspection/review of all parts of the wafer. For this reason, it is thought that sampling is performed so that defects to be subjected to the detailed inspection/review are relatively uniformly distributed on the wafer. However, it is known that many of defects detected by the inspection apparatus are defects which do not relate to hot spots such as foreign materials. This also produces a problem that it becomes difficult to extract hot spots.

Therefore, according to the present invention, first of all, for example, in the detailed inspection/review defect selection unit 1183 of the total controller 118 included in the reviewing apparatus 90, as shown in FIG. 4, the position-of-interest group data 401 on the design data such as predetermined hot spots (in CAD coordinate system on the wafer) is compared with a position 402 of defect coordinates by a comparison unit 403. Here, the position-of-interest group data 401 is acquired by evaluation using the lithography simulation in the design data server 202, or the like, and is then stored in for example the storage device 116. On the other hand, the position 402 of defect coordinates is determined by the inspection apparatus 201, and is then stored in the storage device 116. If these positions are substantially the same, it is identified as a defect closely relating to a failure in properties that is caused by a shortage of a process margin in a hot spot. This defect position is extracted and determined as a position (sampling position) to be subjected to detailed inspection/review. Then, the determined position (sampling position) to be subjected to the detailed inspection/review is stored in the storage device 116.

However, defect coordinates, which are output from the inspection apparatus 201, include an error of a stage system that travels with a wafer being placed thereon. The error of this stage system is very large in comparison with the size of a pattern in which a defect to be subjected to detailed inspection/review exists. This is a problem to be solved. Therefore, according to the present invention, for example, if the comparison unit 403 of the detailed inspection/review defect selection unit 1183 of the total controller 118 compares two positions, first of all, an error of a stage system, the amount of which is about ±5 μm, is taken into consideration. Accordingly, if a deviation of the position data 402 of a defect coordinate group from the position data 401 of a point-of-interest group on design data (in the coordinate system on the basis of the CAD data on the wafer) falls within this error range (more specifically, if the deviation is smaller than or equal to the coordinate precision of the stage system of the inspection apparatus 201), the position data is identified as a sampling candidate to be subjected to the detailed inspection/review.

Moreover, because the wafer is placed on a stage with reference to an external shape, it is thought that there is a case where an alignment error of about 20 μm may occur in defect coordinates that are output from the inspection apparatus 201. The reason is as follows. Inspection is usually performed in the inspection apparatus 201 by comparing images obtained from adjacent chips that are arrayed on a semiconductor wafer. Accordingly, if the chip size is correct, the inspection can be carried out. Therefore, it is not always necessary to correctly align a stage coordinate system of the inspection apparatus 201 with an alignment coordinate system (a x-y coordinate system on the wafer) with reference to an alignment pattern.

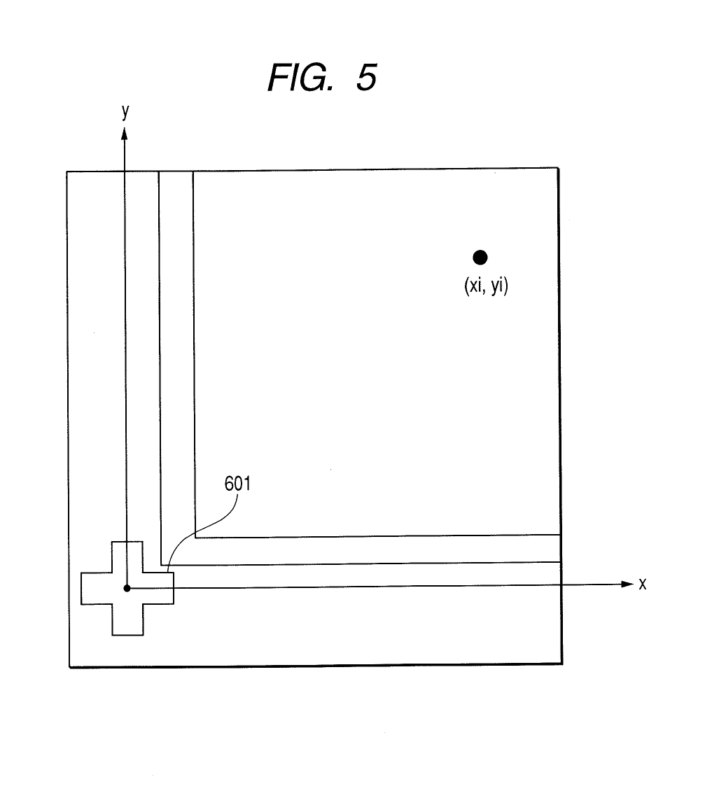

Incidentally, as shown in FIG. 5, the alignment pattern 601 is drawn on a semiconductor wafer of an imaging target on an exposure basis (on a shot basis) when a mask is exposed to light. Accordingly, it is possible to image the alignment pattern 601 by use of the microscope 100 of the reviewing apparatus 90 so as to detect its position. Incidentally, the alignment pattern 601 may also be a typical unique pattern that can be aligned, and that is drawn on a semiconductor wafer.

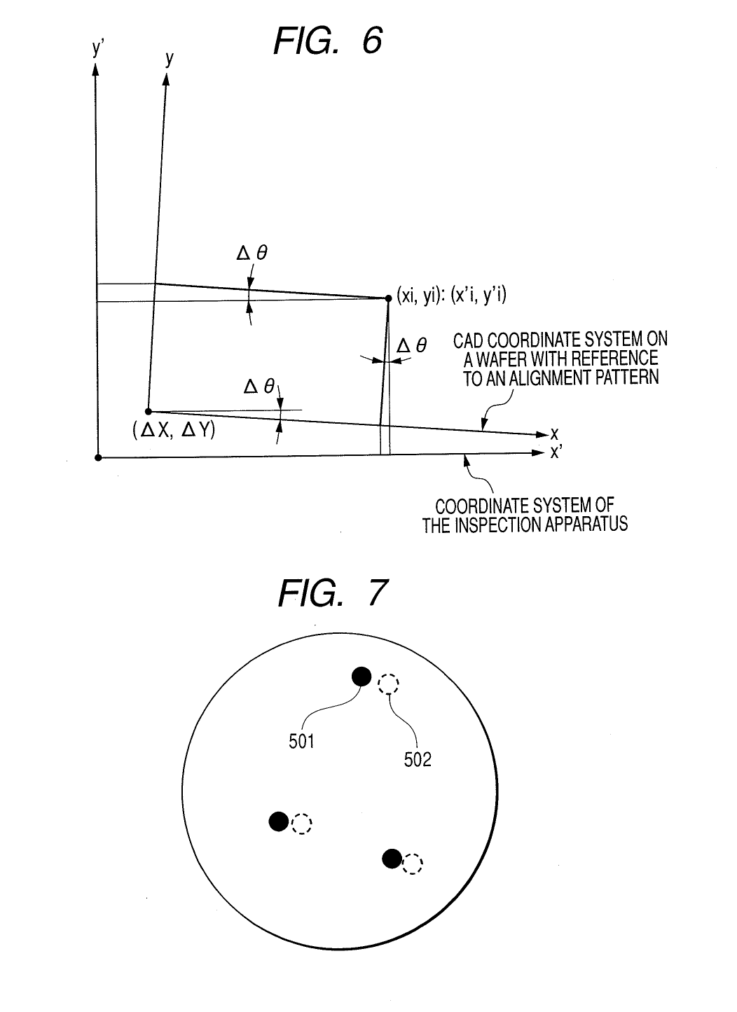

Therefore, in the reviewing apparatus 90 according to the present invention, a plurality of alignment patterns selected from among alignment patterns formed on a semiconductor wafer on an exposure basis (typical unique patterns which can be aligned may also be used) are imaged by the microscope 100 (the SEM or the optical microscope) included in the reviewing apparatus 90. Then, these positions are detected by the defect detecting unit 1151 of the image processing unit 115, or the like. After that, on the basis of the detected position information, the alignment coordinate system (the x-y coordinate system on the basis of the CAD shown in FIG. 6) is set by for example the alignment error correction equation calculation unit 1181 of the total controller 118. From among the defects that are output by the inspection apparatus 201 on the basis of the set alignment coordinate system, for example, positions of defects, the number of which is selected on a screen of the display unit 117, are imaged and detected by the microscope 100 again so that coordinates of the position of the defects are determined by the defect detecting unit 1151 of the image processing unit 115. As a result, for example, in the alignment error correction equation calculation unit 1181 of the total controller 118, the relationship of an alignment error correction equation with reference to the plurality of alignment patterns (a correction coefficient and an offset error (ΔX, ΔY) on the basis of a deviation angle (Δθ) of the equation (1) described below) is determined from the relationship of the following equation (1). Here, the relationship of the alignment error correction equation is an alignment coordinate system in the reviewing apparatus 90 (the x-y coordinate system on the basis of the CAD data). Then, the relationship can be stored in the storage device 116. At this time, position coordinates of the defects, the number of which is selected, are stored in the storage device 116 from the inspection apparatus 201. Accordingly, the relationship of the alignment error correction equation is determined.

Thus, as a result of determining the relationship of the alignment error correction equation, for example, the inspection apparatus output defect coordinate correction unit 1182 of the total controller 118 uses the undermentioned equation (1) to successively perform inverse operation for a large number of defects output from the inspection apparatus 201 on the basis of position coordinates (x′i, y′i) of each of the defects, and thereby calculates the position coordinates (xi, yi) of each of the defects in the alignment coordinate system (x-y coordinate system on the basis of the CAD data on the wafer) whose alignment error has been corrected. As a result, as shown in FIG. 4, it becomes possible to compare the position coordinates (xi, yi) with the position data 401 of the point-of-interest group on the design data such as a hot spot (in the coordinate system on the basis of the CAD data on the wafer).

Incidentally, FIG. 6 shows the relationship between the x-y coordinate system for determining defect position coordinates (xi, yi) with reference to a plurality of alignment patterns in the reviewing apparatus 90 and an x′-y′ coordinate system in which a defect coordinate position (x′i, y′i) is detected by movement of a stage without alignment by the normal inspection apparatus 201. To be more specific, as shown in FIG. 7, on the assumptions that the defect position coordinates which have been determined in the x-y coordinate system with reference to a plurality of alignment patterns selected in the reviewing apparatus 90 is (xi, yi) (501), and that defect position coordinates in the x′-y′ coordinate system, which have been output from the inspection apparatus 201, is (x′i, y′i) (502), for example, the alignment error correction in the inspection apparatus output defect coordinate correction unit 1182 of the total controller 118 is achieved by determining a correction coefficient and an offset error (ΔX, ΔY) on the basis of a deviation angle (Δθ) of the undermentioned equation (1) by the alignment error correction equation calculation unit 1181. Thus, because there are three unknown quantities, if the positional relationship between alignment patterns is known on the basis of CAD data, it is necessary to image at least three alignment patterns by use of the microscope 100 in the reviewing apparatus 90 to determine the position. As a matter of course, if the positional relationship between alignment patterns is not known, it is necessary to determine a position of each alignment pattern in the reviewing apparatus 90, and to determine the positional relationship between the alignment patterns.

$$( \begin{matrix}{x}_{i}^{′} \\ {y}_{i}^{′}\end{matrix} ) = ( \begin{matrix}cos Δθ & sin Δθ \\ - sin Δ θ & cos Δθ\end{matrix} ) ( \begin{matrix}{x}_{i} \\ {y}_{i}\end{matrix} ) + ( \begin{matrix}Δ X \\ Δ Y\end{matrix} ) \qquad Equation 1$$

Therefore, for example, if the detailed inspection/review defect selection unit 1183 of the total controller 118 performs defect selection for detailed inspection/review described in FIG. 4 with respect to the defect coordinates 402 obtained from the inspection apparatus 201 after the alignment error correction is performed on the basis of the equation (1), the reviewing apparatus 90 can accurately review, from a design pattern, a defect of a sampling candidate that coincides with the position data 401 of a point of interest. Incidentally, in the above description, the CPU included in the total controller 118 executes the processing. However, the processing may also be executed in the computer terminal connected to the total controller 118.

In addition, in the case of the embodiment shown in FIG. 3, steps 1181 through 1183 to be executed by the total controller 118 will be executed by the defect server 301.

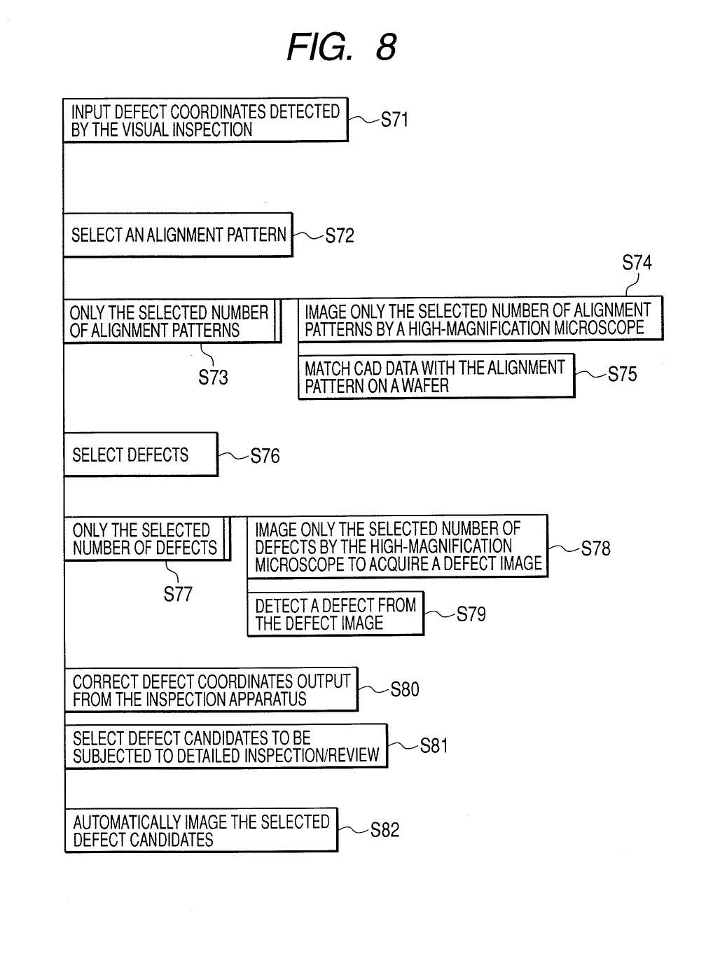

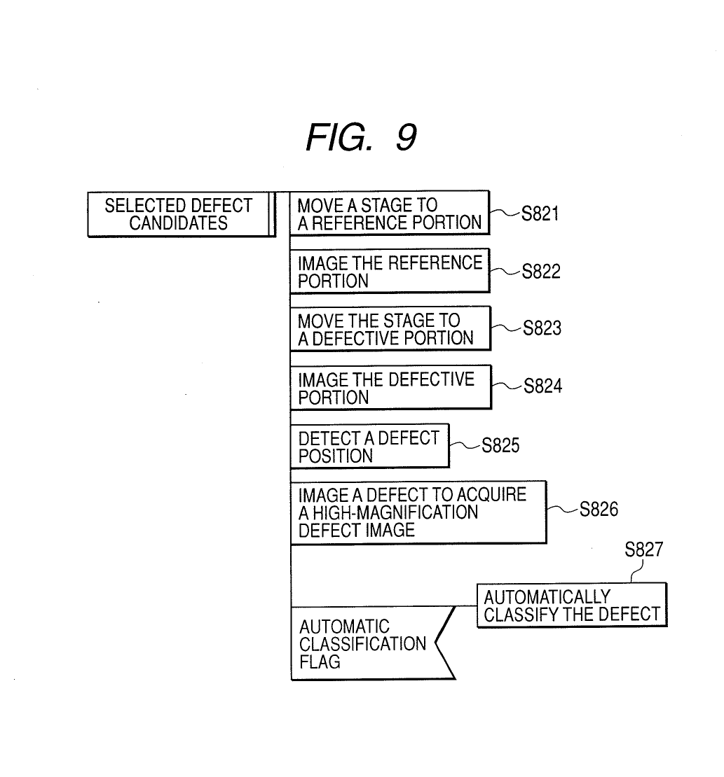

Next, a first embodiment of the process flow in which detailed inspection/review of a defect is automatically performed on the basis of defect coordinates detected from the inspection apparatus 201 in the reviewing apparatus 90 (including the defect server 301) will be described with reference to a PAD diagram shown in FIGS. 8, 9.

The first embodiment shown in FIG. 8 corresponds to a case where detailed inspection/review of one wafer is performed. Design information about a semiconductor wafer inspected by the visual inspection apparatus 201 is inputted into the data input unit 119 of the reviewing apparatus 90 (including the defect server 301) beforehand. Here, the design information includes: information about the position data 401 of a point of interest on design data such as a predetermined hot spot obtained from the design data server 202 (in a coordinate system on the basis of CAD data); and design information (CAD data) about position coordinates of a plurality of alignment patterns 601 formed on an exposure basis. The design information is converted into a SEM image by the design-data converter 120 if necessary, and is then stored in the storage device 116.

Next, in the reviewing apparatus 90 (including the defect server 301), defect coordinates detected by the visual inspection apparatus 201 are inputted into, for example, the data input unit 119. The inputted defect coordinates are then stored in the storage device 116 (S71). Next, in the reviewing apparatus 90 (including the defect server 301), the total controller 118 displays, on the display unit 117, the plurality of alignment patterns 601 that are stored in the storage device 116, and that are formed on an exposure basis. On a screen displaying the alignment patterns 601, for example, the desired number of alignment marks, which are spaced away from one another on a semiconductor wafer, are selected (S72). Only the selected number of alignment patterns (S73) are imaged by use of, for example, an optical or SEM high-magnification microscope 100 included in the reviewing apparatus 90 (the optical high-magnification microscope is not shown in FIG. 1), and are then stored in the memory 113 (S74). For example, the image processing unit 115 performs matching between a high-magnification image of the alignment pattern stored in the memory 113 and CAD data (an optical or SEM image of each alignment pattern) stored in the storage device 116 to calculate a position of each of the alignment patterns. On the basis of the calculated position of each of the alignment patterns, the total controller 118 sets an alignment coordinate system (an x-y coordinate system on the basis of the CAD data on the wafer) (S75).

Next, in the reviewing apparatus 90 (including the defect server 301), the defects inputted in the step S71, which are stored in the storage device 116, are displayed on the display unit 117. Then, on the screen displaying the defects, one or more defects are selected from among the defects (S76). Only the selected number of defects (S77) are imaged by use of, for example, the high-magnification microscope 100 included in the reviewing apparatus 90 on the basis of the alignment coordinate system set by the total controller 118. The imaged defect images are then stored in the memory 113. The defect detecting unit 1151 of the image processing unit 115 compares each of the stored defect images with a reference image to detect position coordinates of each defect. The position coordinates are stored in the storage device 116 (S79). Therefore, the alignment error correction equation calculation unit 1181 of the total controller 118 determines the relationship of the alignment error correction equation (a correction coefficient and an offset error (ΔX, ΔY) on the basis of a deviation angle (Δθ)) from the relationship of the above-described equation (1), and then stores the relationship in the storage device 116. As a result, the inspection apparatus output defect coordinate correction unit 1182 of the total controller 118 uses the relationship of the alignment error correction equation to perform the inverse operation by use of the above-described equation (1) on the basis of defect position coordinates (x′i, y′i) of the large number of defects in the x′-y′ coordinate system, which are output from the inspection apparatus 201, and which are stored in the storage device 116. Consequently, position coordinates (xi, yi) of each of the defects in the x-y coordinate system (x-y coordinate system based on the CAD data on the wafer), whose alignment error has been corrected, are calculated, and are then stored in the storage device 116 (S80).

Next, as shown in FIG. 4, the detailed inspection/review defect selection unit 1183 of the total controller 118 compares information about the position data 401 of a point of interest on design data such as a hot spot stored in the storage device 116 (in the x-y coordinate system based on CAD) with position data of a group of a large number of defect coordinates whose alignment error has been corrected, and thereby selects, as a defect candidate to be subjected to detailed inspection/review (a defect candidate to be sampled), a defect whose distance from the point of interest of the defect is shorter than the precision of coordinates in a stage system of the inspection apparatus 201, and which accordingly can be identified as a hot spot. Then, the selected defect candidate is stored in the storage device 116 (S81). This selection may also be made on the screen of the display unit 117.

Lastly, the plurality of selected defect candidates stored in the storage device of the reviewing apparatus 90 are imaged by use of the SEM microscope 100 to successively perform the detailed inspection/review (S82). In this case, if the defect candidates, which have been selected as the detailed inspection/review (sampling) defect candidates in the step S81, are positioned on the basis of the alignment coordinate system set in the steps S72 through S75, it is possible to execute the detailed inspection/review of the defect candidates by the SEM microscope 100 with each of the defect coordinates being easily placed in a visual field of the SEM microscope 100.

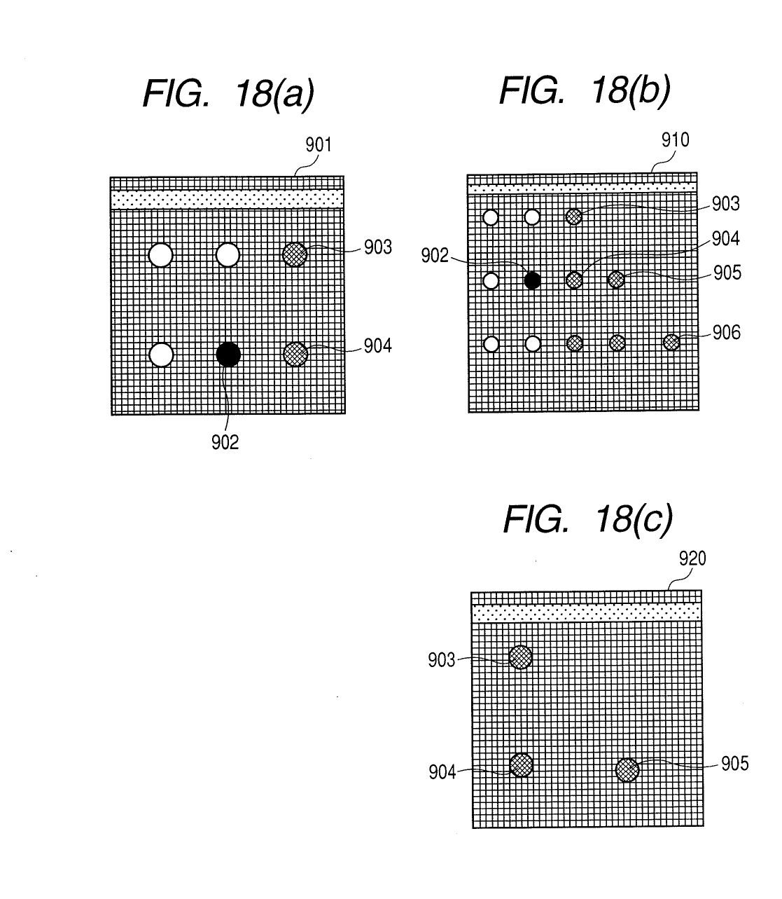

Next, a defect imaging sequence in the step S82 will be specifically described with reference to FIG. 9. FIG. 9 illustrates an imaging sequence that is not accompanied with the correction of coordinates shown in FIG. 18 described below, and illustrates processing that is performed in the step S82 shown in FIG. 8. For the selected defect candidates to be subjected to the detailed inspection/inspection, the detailed inspection/review defect selection unit 1183 performs the processing of the steps S821 through S827. To be more specific, on the basis of an instruction received from the total controller 118, the stage is moved to a reference portion, which is manufactured by the same design as that of the defect coordinates whose alignment error is corrected with respect to defect coordinates of the defect candidates selected in the step S80, so that the visual field is moved (S821). Next, the SEM microscope 100 acquires an image of the reference portion, and then stores the image in the memory 113 (S822). Next, the stage is moved so that the defect coordinate whose alignment error has been corrected with respect to the defect coordinates of the selected defect candidate enters a visual field of the microscope (S823). Then, the SEM microscope 100 performs imaging at the defect position to acquire an image, which is then stored in the memory 113 (S824). After that, the defect detecting unit 1151 of the image processing unit 115 compares the image acquired at the defect position with an image of a reference position to detect position coordinates of the defect (S825). The total controller 118 moves the visual field of the microscope so that the detected defect position becomes the center, and then images the defect to acquire a high-magnification defect image (S826).

Incidentally, if parameters of the detailed inspection/review instruct the execution of automatic classification of defects, then in the step S827, the defects are automatically classified from the images acquired in the steps S822, S824, S826.

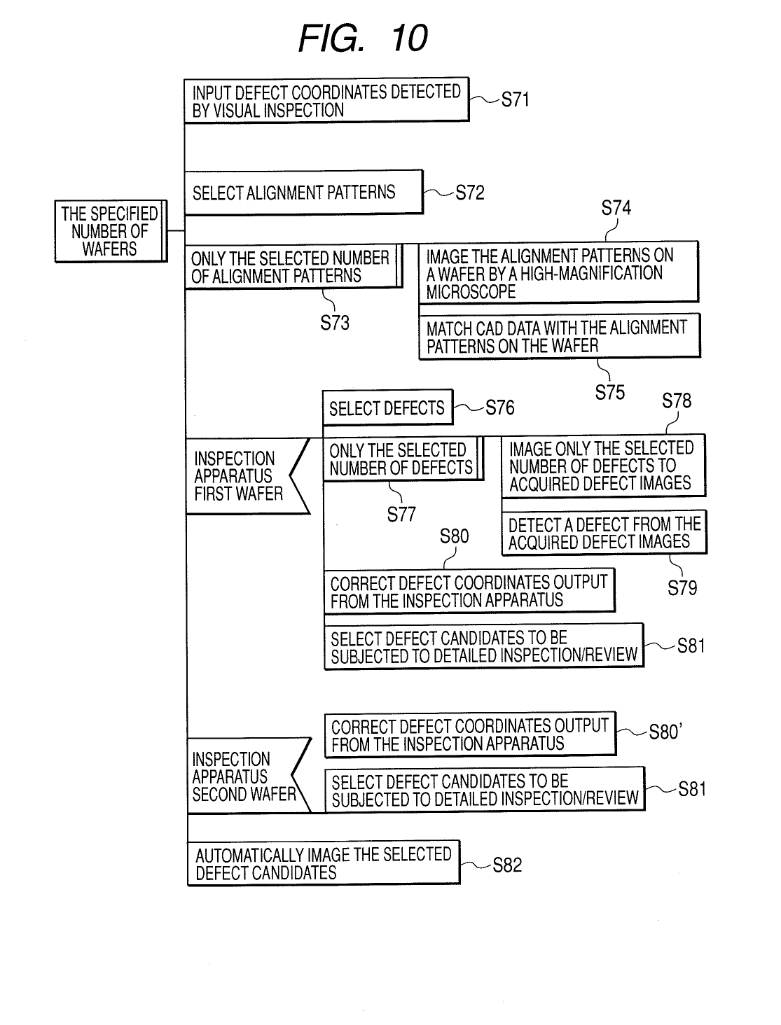

Next, a second embodiment of the process flow in which detailed inspection/review of a defect is automatically performed on the basis of defect coordinates detected by the inspection apparatus 201 in the reviewing apparatus 90 (including the defect server 301) will be described with reference to a PAD diagram shown in FIG. 10. To be more specific, a point of difference between the first and second embodiments is that defects on the same kinds of wafers, the number of which is specified, are subjected to detailed inspection/review. In this case, for example, steps S76 through S79 are executed only for a first wafer to calculate the relationship of an alignment error correction equation with respect to an alignment coordinate system. Then, steps S80, S81 are further executed. Next, for example, for a second wafer or more, a step S80′ is executed. More specifically, the above-described equation (1) is used to perform the inverse operation on the basis of defect position coordinates (x′i, y′i) of the large number of defects in the x′-y′ coordinate system that are output from the inspection apparatus 201 by use of the relationship of the alignment error correction equation with respect to the alignment coordinate system acquired from the first wafer. As a result, position coordinates (xi, yi) of each of the defects in the x-y coordinate system (x-y coordinate system based on CAD data on the wafer), whose alignment error has been corrected, are calculated.

In short, the second embodiment relates to a case where defects on the specified number of wafers are subjected to the detailed inspection/review. In this case, the relationship of the alignment error correction equation with respect to the alignment coordinate system for the second wafer or more is considered to be the same as that for the first wafer. Accordingly, the steps S76 through S79 are omitted to improve the throughput. Incidentally, in the step S82, if the reviewing apparatus 90 positions the defect candidates, which have been selected as the detailed inspection/review (sampling) defect candidates in the step S81, on the basis of the alignment coordinate system set in the steps S72 through S75, the reviewing apparatus 90 can execute the detailed inspection/review of the defect candidates by use of the SEM microscope 100 with each of the defect coordinates being easily placed in a visual field of the SEM microscope 100.

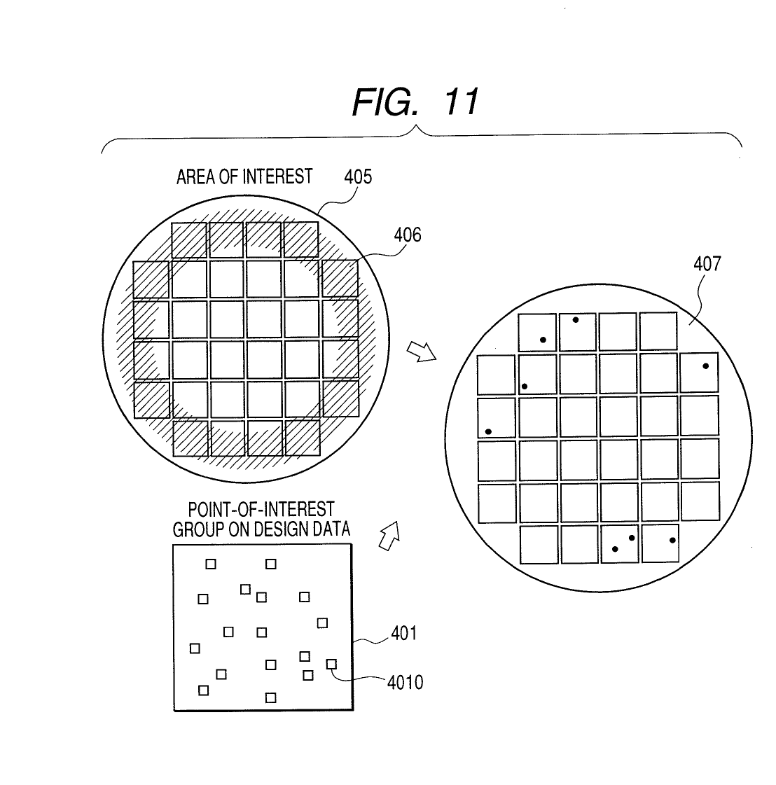

Next, a third embodiment of the process flow in which detailed inspection/review of a defect is automatically performed on the basis of defect coordinates detected from the inspection apparatus 201 in the reviewing apparatus 90 (including the defect server 301) will be described with reference to a PAD diagram shown in FIGS. 11 through 17. In contrast to the first and second embodiments, the third embodiment is so configured that because a position on a semiconductor wafer, at which a defect caused by a process often occurs, is roughly known (for example, outer circumferential part of the wafer), a defect is selected from such a position beforehand so as to selectively perform the detailed inspection/review of the defect caused by the process. In FIG. 11, reference numeral 405 denotes the semiconductor wafer; and reference numeral 406 denotes an area of interest (the position at which the defect caused by the process occurs) that is set on the wafer 405 by use of the display unit 117, or the like, the area of interest being stored in the storage device 116.

On the other hand, reference numeral 401 denotes a point-of-interest group such as a hot spot, which is determined by lithography simulation, or the like, on the basis of CAD data in the design data server 202, and which is stored in the storage device 116. Reference numeral 407 denotes defect coordinates to be reviewed, whose alignment error has been corrected by the steps S72 through S80 shown in FIG. 8. The defect coordinates corresponds to an area surrounding the position of interest of the reference numeral 406 (the area of interest), and accordingly only a defect detected around the point-of-interest group 401 is selected. Thus, it becomes possible to select the defect caused by the process. Incidentally, although the area of interest shown in the reference numeral 406 can be explicitly set as a recipe by a user using the display unit 117, how defects output from the inspection apparatus are distributed may also be analyzed by, for example, the total controller 118 by adopting, for example, the method shown in FIG. 1 of JP-A-2003-59984 (patent document 4). After the analysis, an area of the distribution state corresponding to a process failure is identified as an area of interest.

The technique shown in FIG. 11 is a method for setting an area of interest on the basis of a macro defect distribution state of a wafer. However, it is also possible to carry out this on the basis of coordinates in a wafer chip.

Up to this point, the technique for performing detailed inspection/analysis on the basis of the defect coordinates output by the visual inspection apparatus 201 was described. However, the defect coordinates of the visual inspection apparatus 201 are not always subjected to the detailed inspection/review. The detailed inspection/review defect selection unit 1183 of the total controller 118 may also further narrow down the areas of interest of defect management so as to determine the area of interest as a point to be subjected to the detailed inspection/review on the basis of the identified point-of-interest group 401, which is acquired by making an evaluation using the lithography simulation in, for example, the design data server 202, or the like, and which is stored in, for example, the storage device 116, and on the basis of the result of the detailed inspection/review performed beforehand

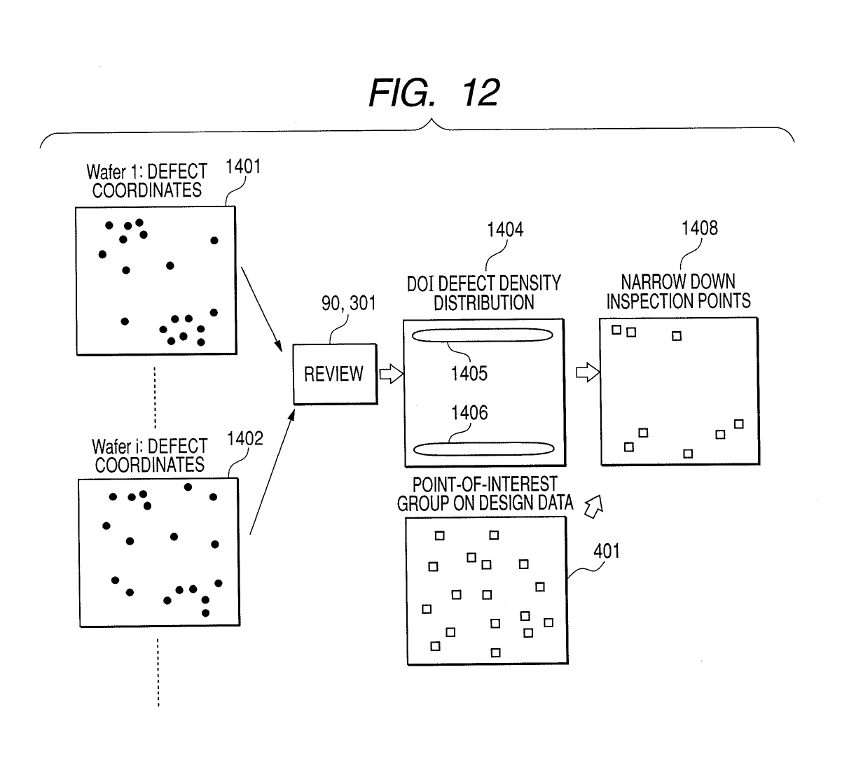

FIG. 12 is a diagram illustrating an embodiment thereof. Each of reference numerals 1401, 1402 denotes a wafer map in which defects on a large number of inspected wafers, which are output by the visual inspection apparatus 201 and are then stored in the reviewing apparatus 90 or the defect server 301, are plotted on the basis of chip coordinates. Incidentally, the above-described wafer map may also be subjected to alignment error correction by the steps S72 through S80 shown in FIG. 8. In addition, the reviewing apparatus 90 or the defect server 301 is capable of: excluding defects which are little associated with process fluctuations, such as foreign materials, and excluding nuisance defects such as grain, on the basis of the defect coordinates output from the inspection apparatus 201 to extract defects of interest; and indicating the extracted defects of interest, that is to say, an area 1404 in which DOIs (Defect of Interest) are distributed, on the basis of chip coordinates, and then storing the defects of interest in the storage device 116. Incidentally, in the above-described area 1404, defects which are associated with the process fluctuations are concentrated on areas 1405, 1406.

Moreover, reference numeral 401 denotes a point-of-interest group that is easily influenced by the process fluctuations determined by lithography simulation, or the like, in the design data server 202. The point-of-interest group is inputted into the reviewing apparatus 90, and is then stored in, for example, the storage device 116. In general, it is difficult for the reviewing apparatus 90 to carry out detailed inspection/review of all points of interest. Therefore, the detailed inspection/review defect selector 1183 of the total controller 118 can narrow down points to be subjected to detailed inspection/review to a wafer map 1408 by combining the point of interest 401 stored in the storage device 116 with the area 1404 that is easily influenced by the process fluctuations.

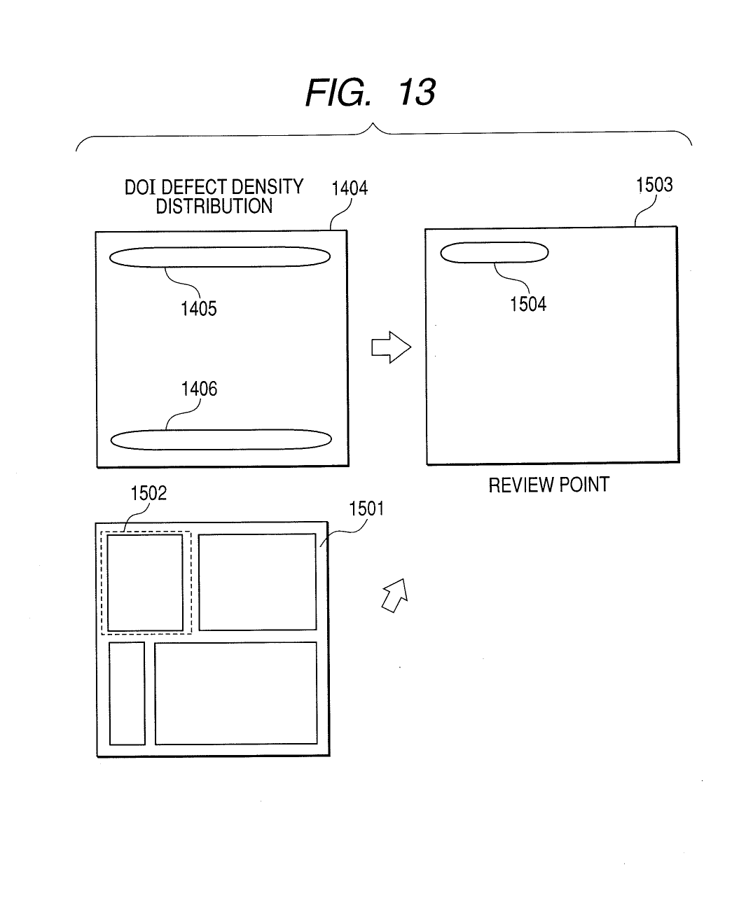

Moreover, FIG. 13 illustrates a method in which a user specifies an area of interest on the screen of the display unit 117 to perform detailed inspection/review. This method is further developed from the method shown in FIG. 12. A semiconductor chip is provided with functions on an area basis. For example, the semiconductor chip includes: a cache unit, and a flash memory unit, each of which is characterized by the high density and has repetitive patterns on appearance; and a logic unit, and a data input/output unit, each of which is formed of unrepeated patterns. When detailed inspection or/and analysis is performed, it is important to associate the change in shape of a formed pattern with electric properties of a manufactured semiconductor. For example, the cache unit and the flash memory unit are capable of making a judgment as to whether or not a failure has occurred on a memory bit basis, which is called a fail bit map. Accordingly, it can be easily executed. On the other hand, in the case of deterioration in properties occurred when an operating frequency of the semiconductor is increased, the deterioration in properties is often caused by the logic unit.

Thus, because a point to be managed changes in response to its purpose, it is so devised that a user is allowed to preset an area to be subjected to detailed inspection/review. Reference numeral 1501 is a layout drawing of a chip indicated with CAD data. Reference numeral 1502 denotes one functional block of the chip. This functional block is specified on the screen of the display unit 117 by the user as an area of interest that is to be subjected to detailed inspection/review.

An area 1504 into which the distribution map 1404 in which DOI defects are distributed as shown in FIG. 12 and the area of interest 1502 specified by the user are combined is set as an area to be subjected to the detailed inspection/review. By applying, instead of the area 1404, an area 1503 that has been set in this manner, the detailed inspection/review defect selector 1183 of the total controller 118 can further narrow down the points to be managed.

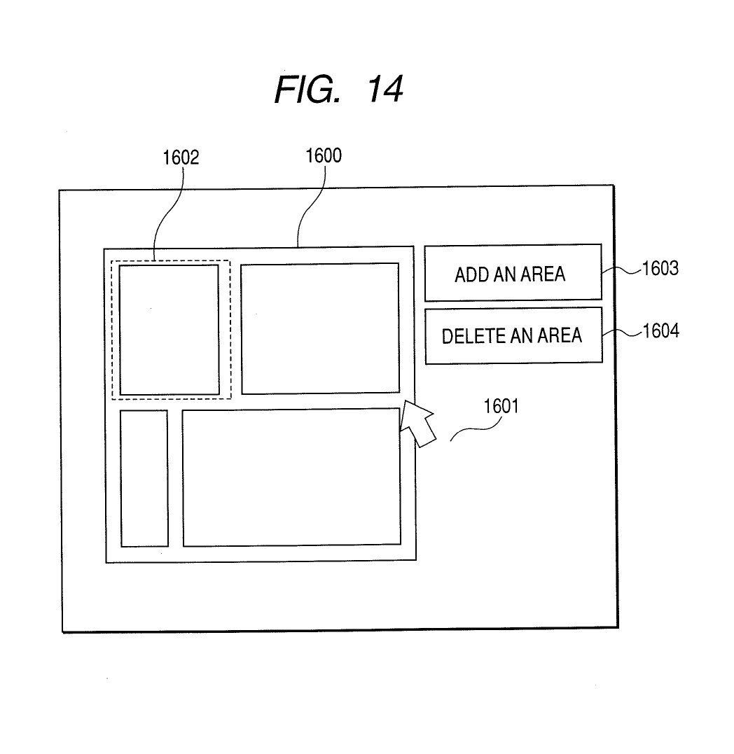

FIG. 14 is a GUI screen of the display unit 117, on which the functional block 1502 is set. A chip layout or an overview imaged by a microscope is displayed in an area 1600. An area to be subjected to detailed inspection or/and review is determined by use of a pointer 1601 as shown in an area 1602. Reference numeral 1603 denotes a button that is used to add an area. By moving the pointer to this button, the process enters an area addition mode. On the other hand, by moving the pointer to a button 1604, it is possible to delete an area.

FIGS. 12 through 14 illustrate the method in which the area 406 to be subjected to detailed inspection/review is set in the chip to narrow down the predetermined point-of-interest group 401 on the design data. However, it may also be so configured that a distribution state of the defects on the wafer, which is output from the inspection apparatus 201, is analyzed by the total controller 118, and then only for chips included in this high-density area 1703, the detailed inspection/review defect selector 1183 selects the point-of-interest group 401 as detailed inspection/review defects.

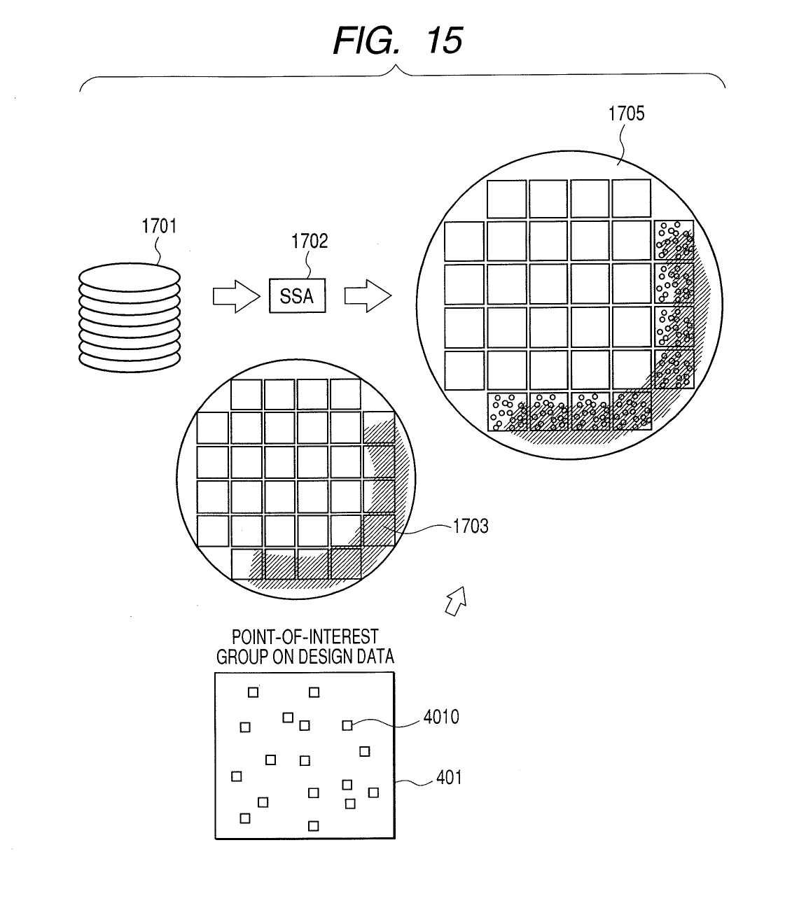

FIG. 15 is a diagram illustrating one embodiment of this method. A difference between this method and the method shown in FIG. 11 will be described as below. In the method shown in FIG. 11, the area 406 which is close to the point of interest 4010, and which is in the distribution state corresponding to a process failure based on the distribution state of the defects, is selected, as a point of interest, from among the defects output from the defect inspection apparatus 201. On the other hand, in this embodiment, even if no defect is detected in an area in proximity to a point of interest, if the area in proximity to the point of interest includes a defect distribution pattern corresponding to the process failure, the detailed inspection/review of the point of interest is performed.

In general, as the optical inspection apparatus 201 that is applied in a production line of semiconductors, there is an inspection apparatus that uses both a bright-field detection system and a dark-field detection system. However, in particular, in the case of a particle inspection apparatus that uses the dark-field detection system, the pixel size of a detected image is large relative to the pattern size. Accordingly, even if the pattern size is magnified or demagnified to some extent, it is often not possible to detect the magnification or the demagnification. Because of it, even if these defects have occurred at the point of interest, there is a high possibility that the defects would be overlooked. Accordingly, on the basis of a distribution state of the defects, which is a more macro view, if it is judged that there is a possibility that a defect would occur at the point of interest, the detailed inspection/review of the point of interest is performed.

Incidentally, if the method described in FIG. 15 is used in combination with the method in which a point-of-interest group is narrowed down in a chip, which is described in FIGS. 12 through 14, it becomes easier to extract defects of interest with higher efficiency. This makes possible to facilitate monitoring of a manufacturing state.

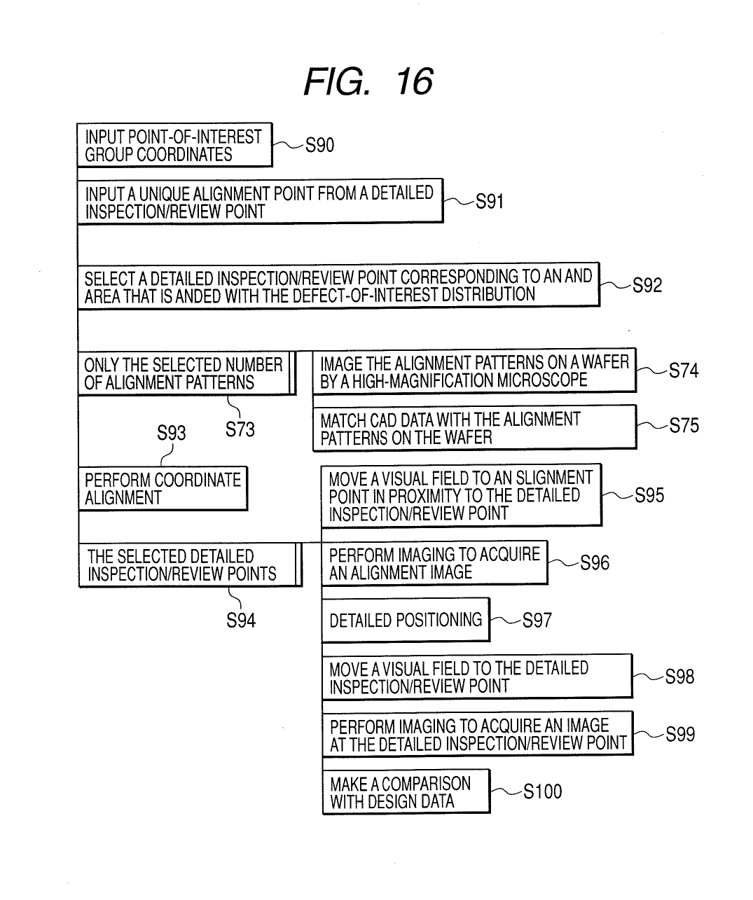

FIG. 16 is a flowchart illustrating one embodiment of a sequence of detailed inspection/review that is performed after the point-of-interest group 401 is set as shown in FIG. 15. In a step S90, point-of-interest group coordinates expressed with chip coordinates (that is to say, the point-of-interest group 401) are inputted into the reviewing apparatus 90 from the design data server 202, and are then stored in the storage device 116. In a step S91, alignment point coordinates, which are used as the reference of the point-of-interest group coordinates expressed with the chip coordinates, are inputted into the reviewing apparatus 90 from the design data server 202, and are then stored in the storage device 116. Incidentally, it is not always necessary to input, in the step S91, the alignment point coordinates that are used as the reference of the chip coordinates. The alignment point coordinates may also be automatically calculated by the total controller 118 from both the point-of-interest group coordinates 401 expressed with the chip coordinates stored in the storage device 116 and the inputted CAD data.

Next, the total controller 118 acquires the detailed inspection/review points 1705 by extracting coordinates whose in the point-of-interest group coordinates 401, distance from the distribution of defects of interest 1703 is near, the distribution of defects of interest 1703 being acquired by spatial signature analysis (SSA) 1702 on the basis of a multiplicity of wafers 1701 as shown in FIG. 15. Then, the total controller 118 stores the acquired detailed inspection/review point 1705 in the storage device 116 (S92). Next, in the steps S73 through S75, from an alignment pattern that is formed on a chip basis on a wafer, the total controller 118 matches an image of an alignment pattern formed on a chip existing the above-described defect distribution with an image of an alignment pattern on CAD data so as to perform coordinate alignment of the detailed inspection/review point 1705 (S93). Next, on the basis of an instruction received from the total controller 118, detailed inspection/review points, which has been aligned, are subjected to imaging and inspection (steps S94 through S100).

To be more specific, the total controller 118 moves a visual field to an alignment point that is set at a position in proximity to the detailed inspection/review point of interest (S95). After that, the total controller 118 performs imaging to acquire an image at the alignment point, and then stores the image in the memory 113 (S96). The image processing unit 115 matches the image of the alignment point stored in the memory 113 with an expected CAD image obtained from the design-data converter 120 to calculate the amount of deviation (S97). Then, the total controller 118 moves a visual field to the detailed inspection/review point on the basis of the result of the matching (the amount of deviation) under the control of the scanning units 105, 106 of the SEM.

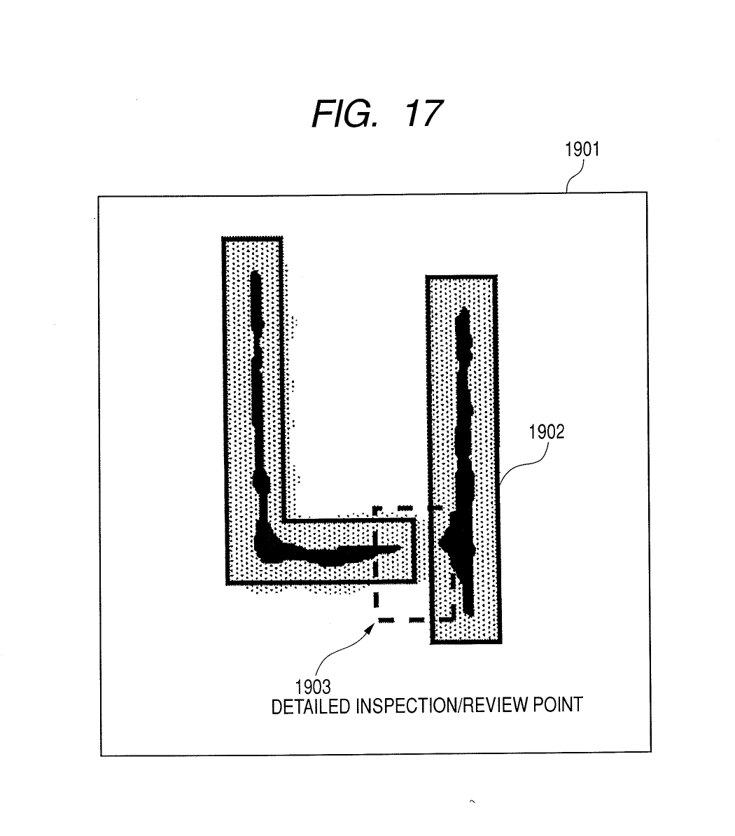

Next, imaging is performed by use of the SEM microscope 100 to acquire an image at the detailed inspection/review point. The acquired image is stored in the memory 113 (S99). The image processing unit 115 then compares the image stored in the memory 113 with design data stored in the storage device 116 to measure the lightness of a pattern corresponding to the amount of deformation of a shape and the voltage contrast, and thereby extracts defects, and data of the amount of process fluctuations (S100). FIG. 17 is a diagram illustrating a comparison method that is executed by the image processing unit 115 in a step S100. Reference numeral 1901 denotes an acquired image that is acquired by the SEM microscope 100; and reference numeral 1902 denotes the required width of a pattern that is set by CAD data. Reference numeral 1903 denotes a detailed inspection/review point. A gap between patterns is measured on the basis of an image at the detailed inspection/review point 1903. Here, the gap between the patterns becomes 0, and accordingly, it is understood that this is a defect.

In addition, in the method for narrowing down defect candidates to perform detailed inspection or review, it is also possible to further narrow down the defect candidates in consideration of defect classification information which is output from the inspection apparatus 201 together with defect positions, the defect classification information including at least one of the result of defect classification, the lightness of defective part, the size of defective part, and the lightness of a difference image of the defective part.

Up to this point, the selection method for selecting defect candidates to be subjected to detailed inspection/review in the reviewing apparatus 90 was described. However, although an alignment error is corrected by this method, it is not possible to hold a position of each defect candidate to be subjected to the detailed inspection/review with the accuracy higher than or equal to that of coordinates (about ±5 μm) of the stage system of the inspection apparatus 201. To be more specific, even if the alignment error (Δθ, ΔX, ΔY) is corrected, the coordinate precision of the stage system of the inspection apparatus 201 is remained at the level of about ±5 μm. On the other hand, because the pitch of wiring to be reviewed by the reviewing apparatus 90 is becoming 55 nm or less, the accuracy becomes insufficient. The accuracy is actually required to be improved by about two digits. As a result, there is a case where it is not possible to judge a position at which a defect has occurred, which makes it difficult to analyze the defect.

For this reason, next, a fourth embodiment of the reviewing apparatus according to the present invention will be described with reference to FIGS. 18 through 20. In the fourth embodiment of the reviewing apparatus 90, after a defect candidate to be subjected to detailed inspection/review is selected, a detailed position of the defect candidate is calculated with a resolution of about ±10 nm, which is close to the resolution of the SEM.

FIGS. 18A, 18B, 18C are diagrams each illustrating contact holes into which a conductive material is filled as a target to be reviewed. Reference numeral 901 denotes an image that is acquired by reviewing an area in proximity to a defect candidate 902 selected by the detailed inspection/review defect selector 1183 of the total controller 118, with the SEM microscope 100 in the reviewing apparatus 90. Because the defect candidate 902 is imaged in black with the SEM microscope 100, the defect detecting unit 1151 of the image processing unit 115 can judge that the defect candidate 902 is a defect caused by a contact failure with a conductivity line in an upstream process.

Although the lightness of contact holes 903, 904 changes to some extent, it is not possible to judge from this image whether or not it is a normal pattern. However, in particular, in the case of logic, a pattern having contact with a contact hole inside the wafer has different electrical properties. This difference in electrical properties inside the wafer causes the lightness of the contact hole to change. Therefore, in order to judge whether or not the contact holes 903, 904 are normal, if it is possible to know a circuit that is connected to each of the contact holes 903, 904, it is possible to estimate the variation of the change in lightness of a surface on the basis of the design information of the circuit. However, in particular, as understood from the image 901 shown in FIG. 18A, in the case of a periodic image, it is not possible to correctly determine the correspondence between this image and the CAD data only from the image.

For this reason, according to the fourth embodiment of the present invention, for example, imaging is performed with the SEM microscope 100 to acquire unique images 910, 920 each having an aperiodic pattern as shown in FIGS. 18B, 18C in proximity to the defect candidate 902 selected from, for example, the detailed inspection/review defect selector 1183 of the total controller 118. The unique images 910, 920 are then stored in the memory 113. The image 910 shown in FIG. 18B is an image whose visual field at the time of imaging is made wider than that of the image 901 shown in FIG. 18A. The image 910 includes aperiodic patterns (unique patterns) 905, 906 that have been imaged. Accordingly, a design unique image is combined by the design unique image combining unit 1201 of the design-data converter 120 on the basis of CAD data in proximity to the defect candidate 902 that is selected by, for example, the detailed inspection/review defect selector 1183 of the total controller 118. The design unique image is then matched with the unique image 910 stored in the memory 113 by the matching unit 1152. This enables the detailed defect position calculation unit 1153 to extract the aperiodic patterns (unique patterns) 905, 906, and to correctly determine positions of the contact holes 902, 903, 904 on the CAD data on the basis of CAD data of the extracted aperiodic patterns (unique patterns) 905, 906. As a result, by estimating the variation of the change in lightness of surfaces of the contact holes 903, 904 from the CAD data, it becomes possible to judge on the basis of the images of the contact holes 903, 904 shown in FIG. 18A whether or not it is normal. This enables detailed analysis. To be more specific, by correctly determining, with a resolution of about ±10 nm, the correspondence between a high-magnification SEM image of a selected defect candidate and CAD data in proximity to the defect candidate, detailed analysis of the selected defect candidate becomes possible.

In addition, a unique image 920 shown in FIG. 18C is an image whose visual field moved with the size of the visual field being fixed. The matching unit 1152 for performing matching with a design unique image of the image processing unit 115 automatically extracts a unique pattern area (unique pattern (aperiodic pattern) whose position can be identified) 905, which is easily aligned, from imaged CAD data I(x, y) in proximity to the defect position selected by the detailed inspection/review defect selector 1183, the imaged CAD data I(x, y) being combined by the design unique image combining unit 1201, and being stored in the storage device 116. Then, a visual field is moved to a position in proximity to the unique pattern area, and imaging is performed there by the SEM microscope 100. At this time, the accuracy of the movement of the stage 114 in the SEM 90 is usually about ±1 μm, which is insufficient in comparison with the pattern pitch. Accordingly, by controlling the scanning units (deflector) 105, 106 shown in FIG. 1 to move the visual field, it is possible to achieve a resolution of about ±10 nm, which is close to the resolution of the SEM. However, a visual field which can be controlled by the scanning units (deflectors) 105, 106 is narrow. Accordingly, in order to identify a position of the defect candidate, a unique pattern area on the CAD data, which is in proximity to the defect candidate, is searched for, and then matching between a high-magnification defect SEM image with high resolution and the unique pattern on the CAD data is performed. This makes it possible to acquire defect position information with higher accuracy. Incidentally, the matching unit 1152 for performing matching with a design unique image of the image processing unit 115 can calculate the unique pattern area 905, which is easily aligned, in proximity to the imaged CAD data I(x, y) by, for example, the following equation (2):

$$min {\sum }_{x , y} {( I ( x , y ) - I ( x + Δ x , y + Δ y ) )}^{2} \qquad Equation 2$$

where I is the brightness of the imaged CAD data.

When coordinates (Δx, Δy) are changed within a constant range at a position other than (0, 0), if a value of the equation (2) is larger than a specified value, it is judged that a similar pattern (periodic pattern) does not exist in proximity thereof and the unique pattern area (unique pattern (aperiodic pattern) whose position can be identified) 905, which is easily aligned, exists there. A position (x+Δx, y+Δy) of the unique pattern area 905 at this time can be identified by use of the coordinates (Δx, Δy) with reference to the CAD data.

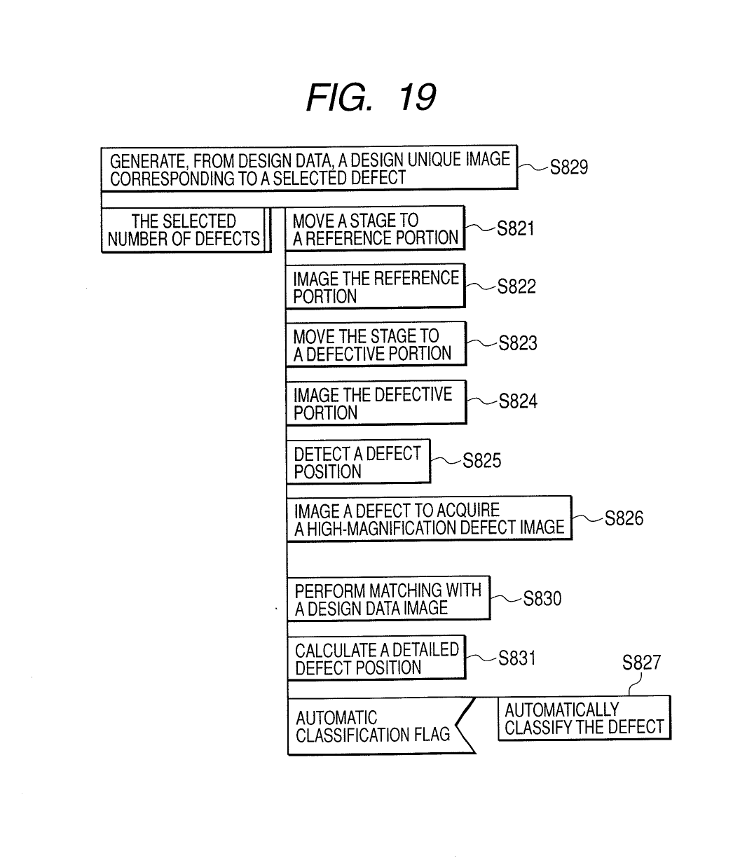

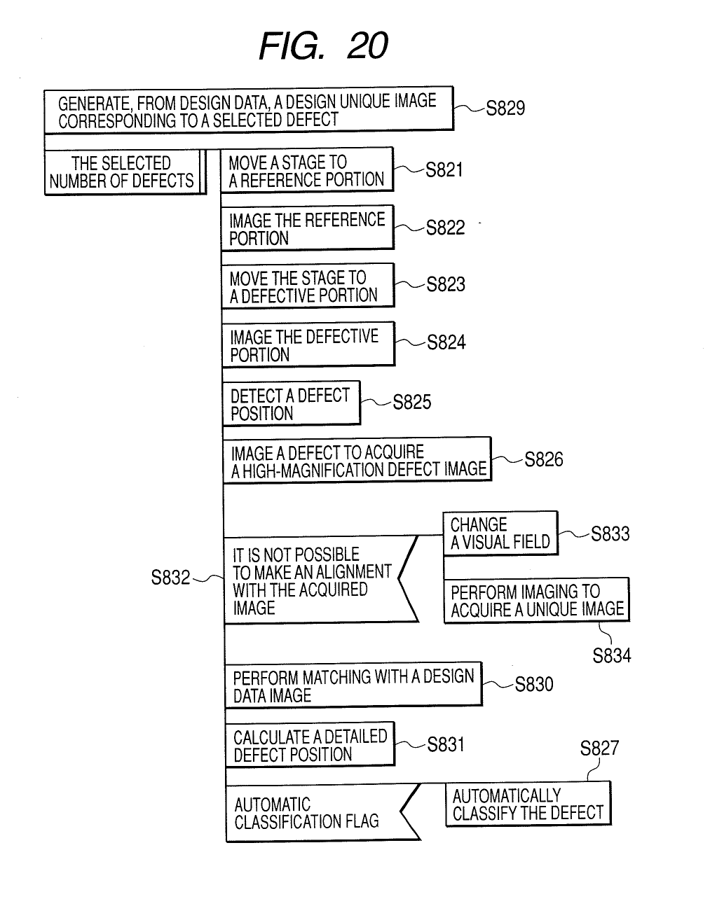

Next, a defect imaging sequence (S82) of the reviewing apparatus 90 according to a fourth embodiment of the present invention will be described with reference to FIGS. 19, 20. FIG. 19 is a chart illustrating an imaging sequence for correcting the coordinates described in FIGS. 18A, 18B, 18C. First of all, a design alignment image combining unit 1201 of the design-data converter 120 performs imaging from CAD data to acquire a design unique image in proximity to a defect position, which is selected by the detailed inspection/review defect selector 1183, and then stores the design unique image in the storage device 116 (S829). Processing in steps S821 through S826 is the same as that shown in FIG. 8. Next, the matching unit 1152 for performing matching with the design unique image of the image processing unit 115 matches the defect image, which has been acquired by imaging and is then stored in the memory 113 in the step S824, with the design unique image that has been combined and is then stored in the storage device 116 in the step S829 (S830). After that, the detailed defect position calculation unit 1153 identifies a position of the defect image on CAD data on the basis of the result of the matching, the defect image being acquired by the imaging in the step S824 (S831). Moreover, if parameters of detailed inspection/review instruct the execution of automatic classification of defects, the image processing unit 115 automatically classifies the defects in the step S827.

However, in the sequence shown in FIG. 19, for example, if there is no pattern in proximity to the defect image acquired by imaging in the step S824 (not illustrated), or if patterns are periodically arrayed (shown in FIG. 18A), it is not possible to normally match the defect image with the design unique image in the step S830. Accordingly, it is not possible to correctly determine defect coordinates on the basis of the CAD data. Therefore, an improved sequence is shown in FIG. 20. FIG. 20 is a chart illustrating one embodiment of a sequence of a method for setting an image 920 shown in FIG. 18 as a design unique image. The step S829 shown in FIG. 12 is basically the same as that shown in FIG. 11. However, in the step S832, the matching unit 1152 for performing matching with the design unique image judges, by use of the above-described equation (2), whether or not the defect coordinates 902 can be set as a design unique image which can be aligned (a position thereof can be identified with high resolution) on the basis of the imaged CAD data I(x, y). In addition, as shown in FIG. 18A, if a design unique image cannot be set, for example, a visual field is changed in proximity to this position as shown in FIG. 18C (S833). Then, an imaging position 920, which can be acquired as a design unique image 905 having a periodicity, is searched for (S834).

Incidentally, in the step S832, a branch judgment is performed. To be more specific, if the image acquired by the imaging in the step S824 cannot be matched (aligned) with the design unique image that is combined from the design data (image whose position can be identified on the CAD data) on the basis of the defect selected in the step S829, the branch judgment for acquiring a design unique image in proximity to the image is performed. If it is not possible to set as the design unique image in the branch judgment performed in the step S832, a visual field of the microscope is moved to the coordinates 920 whose position can be identified in a step S833. Then, in a step S834, an image 920 having an aperiodic design unique image 905 at that point is acquired, and is then stored in the memory 113. After that, the matching unit 1152 for performing matching with the design unique image matches the image 920 stored in the memory 113 with the design unique image, which is combined from the design data, so as to identify a pattern 905. As a result, with reference to a position of the pattern 905 identified on the CAD data, the detailed defect position calculation unit 1153 can calculate a detailed position of the selected defect image 902 with a resolution of about ±10 nm, which is close to the resolution of the SEM. Thereafter, processing in a step S827 is the same as the sequence shown in FIG. 19.

As described above, by the sequence shown in FIG. 20, correct coordinates of the defect which has been subjected to the detailed inspection/review are checked with the resolution that is close to that of the SEM. This facilitates the analysis in combination with the CAD data. In addition, the acquired correct coordinates can also be applied to, for example, a case where the defect which has been subjected to the detailed inspection is analyzed again by an analyzer such as FIB. Therefore, it is desirable to correct the inputted defect coordinates, and then to output the corrected defect coordinates so that the corrected defect coordinates can be inputted into other apparatuses.

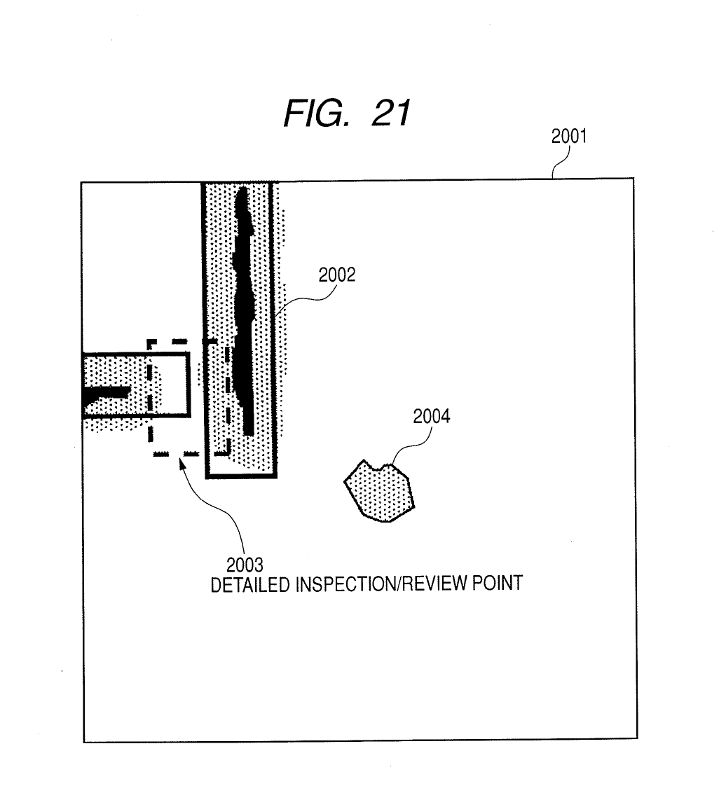

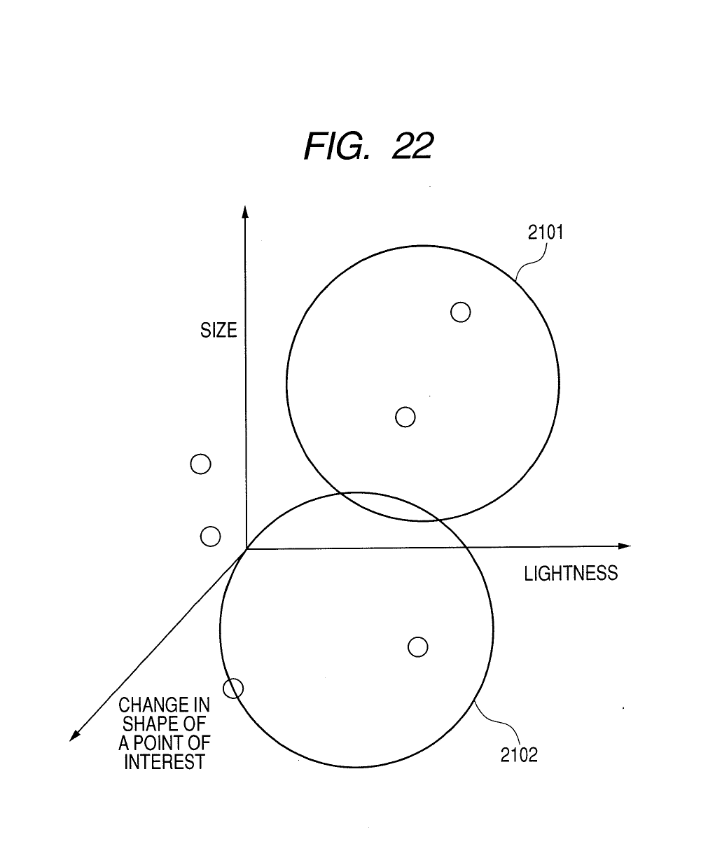

Next, an embodiment of automatic classification of defects according to the present invention will be described with reference to FIGS. 21, 22. To be more specific, there is also a case where, for example, in the detailed inspection/review performed in the defect automatic classification in the step S827 shown in FIGS. 9, 19, which is executed by the image processing unit 115, the defect detected by the inspection apparatus 201 does not always exist at the detailed inspection/review point. FIG. 21 is a diagram illustrating this embodiment. Reference numeral 2001 denotes an imaging visual field; and reference numeral 2002 denotes the required width of a pattern that is set by design data. Reference numeral 2003 denotes a detailed inspection/review point; and reference numeral 2004 denotes a defect detected by the inspection apparatus 201. Imaging is performed with the defect 2004 being located at the center of a visual field to acquire an image of the defect 2004. In FIG. 21, the center of the visual field is placed on the defect that is apart from the detailed inspection/review point. However, at the detailed inspection/review point 2003, a pattern is shortened. Accordingly, it is understood that the pattern may also be influenced by the variation in process. The image processing unit 115, therefore, can automatically classify defects by calculating both the image feature quantity of the image of the defect 2004 (for example, the area) and the image feature quantity (for example, deformation) at the detailed inspection/review point 2003.

Next, FIG. 22 is a diagram illustrating the feature space that is used to automatically classify defects by the image processing unit 115. The image processing unit 115 calculates the feature quantity for the inspected/reviewed defects. The feature quantity includes the size (the area) of a defective portion, the lightness of the defective portion (the volume of the brightness), and deformation of a point of interest. The feature quantity can be plotted in this feature space. Reference numeral 2101 denotes defects that do not directly relate to process fluctuations because these defects are little subject to deformation at the detailed inspection/review point. On the other hand, reference numeral 2102 denotes defects that directly relate to process fluctuations because these defects are subject to deformation at the detailed inspection/review point. Thus, it is possible to separate defects caused by process from the other defects, which makes it easy to perform management of a manufacturing state.

Moreover, in order to facilitate not only the automatic classification but also evaluation by visual inspection, it may be so configured that, as shown in FIG. 21, images are displayed on a GUI screen of the display unit 117, and a detailed inspection/review point area is also displayed on the screen, so that it is possible to easily judge whether or not a defect has occurred in the detailed inspection/review point area.

Furthermore, in the SEM reviewing apparatus according to the present invention, the detailed inspection or review performed in the defect automatic classification in the step S827 shown in FIG. 9, 19, which is executed in the image processing unit 115 including the SEM microscope 100, includes the steps of: imaging a selected defect by moving a visual field of a microscope to acquire a first defect image (S823 through S824); detecting a defect position at high accuracy from the acquired first defect image (S825); setting a visual field, and the magnification, of the microscope on the basis of the detected defect position that is highly accurate, and performing imaging to acquire a second defect image (S826); extracting the image feature quantity of the defect on the basis of the first and second defect images that have been acquired; controlling the scanning units (deflectors) 105, 106 to move the visual field of the microscope to the defect image, the defect position, or a position in proximity to the highly accurate defect position, and thereby performing imaging to acquire an image, which is set as a unique image; comparing the unique image with a design unique image that is acquired by imaging from design data of a semiconductor wafer, and thereby identifying a position of the defect on the design data; and classifying the defect on the basis of the identified position of the defect on the design data and the extracted image feature quantity of the defect.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for reviewing a defect by use of a reviewing apparatus equipped with a SEM, the method comprising the steps of:
inputting positional information of plural defect candidates on a semiconductor wafer, which have been acquired by inspecting the semiconductor wafer with an inspection apparatus, and inputting CAD data of patterns formed on the semiconductor wafer;
calculating positional information on the inputted CAD data of the patterns corresponding to the inputted positional information of the plural defect candidates on the semiconductor wafer;
selecting a defect to be subjected to detailed inspection or review by use of the reviewing apparatus equipped with the SEM on the basis of the calculated positional information of the plural defect candidates on the CAD data; and
performing the detailed inspection or review of the selected defects by use of the reviewing apparatus equipped with the SEM.

2. The method for reviewing a defect by use of the reviewing apparatus equipped with the SEM according to claim 1, wherein:
the inputting step further includes the step of inputting a point-of-interest group to be subjected to detailed inspection or review, which is set on the inputted CAD data; and
the step of selecting a defect further includes the step of selecting a defect to be subjected to the detailed inspection or review in response to a distance between the positional information of the plural defect candidates on the CAD data, which have been calculated in the step of calculating the positional information, and the point-of-interest group that is set to the CAD data, the point-of-interest group having been inputted in the inputting step.

3. The method for reviewing a defect by use of the reviewing apparatus equipped with the SEM according to claim 2, wherein:
the step of selecting a defect further includes the step of narrowing down defects to be subjected to the detailed inspection or review by specifying an area on the semiconductor wafer.

4. The method for reviewing a defect by use of the reviewing apparatus equipped with the SEM according to claim 2, wherein:
the step of selecting a defect further includes the step of narrowing down defects to be subjected to the detailed inspection or review by specifying an area on a chip basis, the chips being arrayed on the semiconductor wafer.

5. The method for reviewing a defect by use of the reviewing apparatus equipped with the SEM according to claim 2, wherein:
the step of selecting a defect further includes the step of narrowing down defects to be subjected to the detailed inspection or review by use of defect classification information that includes at least one of a result of defect classification, a lightness of a defective portion, a size of the defective portion, and a lightness of a difference image of the defective portion.

6. The method for reviewing a defect by use of the reviewing apparatus equipped with the SEM according to claim 1, the method further comprising the steps of:
acquiring a defect image by imaging the defect with a visual field of the SEM moved to a position of the defect selected in the step of selecting the defect, and calculating a defect position on the basis of the acquired defect image;
acquiring a unique image by imaging a unique pattern with the visual field of the SEM moved to the unique pattern, whose position can be identified, in proximity to the calculated defect position on CAD data; and
calculating a detailed position of the defect on the CAD data by comparing the acquired unique image with a design unique image that is acquired by combining from the CAD information.

7. The method for reviewing a defect by use of the reviewing apparatus equipped with the SEM according to claim 1, the method further comprising the steps of:
acquiring a first defect image by imaging the defect with a visual field of the SEM moved to a position of the defect selected in the step of selecting the defect;
calculating a first defect position on the basis of the first defect image that has been acquired;
acquiring a second defect image by imaging the defect with a visual field and a magnification of the SEM on the basis of the first defect position that has been calculated;
calculating image feature quantity of the defect on the basis of the first and second defect images that have been acquired;
acquiring a unique image by imaging a unique pattern in proximity to the first defect position with the visual field of the SEM moved to a position in proximity to the first defect position that has been calculated;
calculating a detailed position of the first defect on the CAD data by comparing the acquired unique image with the CAD data; and
classifying the defect selected in the step of selecting the defect on the basis of the calculated image feature quantity of the defect and the detailed position of the first defect on the CAD data, which has been calculated.

8. A method for reviewing a defect by use of a reviewing apparatus equipped with a SEM, the method comprising the steps of:
calculating an alignment coordinate system by calculating a position on a semiconductor wafer on the basis of positional information of an alignment pattern acquired from CAD data;
calculating positions of selected defect candidates in the alignment coordinate system that has been calculated by processing images acquired by imaging with the SEM about the selected defect candidates selected from among plural defect candidates whose positional information on the semiconductor wafer are known;
calculating relationship of error between the positional information of the selected defect candidates on the semiconductor wafer and the calculated positions of the selected defect candidates in the calculated alignment coordinate system;
correcting the positional information of the plural defect candidates whose positional information on the semiconductor wafer are known, on the basis of the calculated relationship of the error;
selecting defect candidates to be subjected to detailed inspection or review on the basis of the corrected positional information of the plural defect candidates on the semiconductor wafer; and
performing the detailed inspection or review of the selected defect candidates.

9. The method for reviewing a defect by use of the reviewing apparatus equipped with the SEM according to claim 8, the step of calculating the alignment coordinate system further comprising the steps of:
inputting information including: the positional information of the plural defect candidates on the semiconductor wafer, which are acquired by inspecting the semiconductor wafer by use of an inspection apparatus; CAD data of patterns formed on the semiconductor wafer; and information about a point-of-interest group to be subjected to detailed inspection or review, which is set to the CAD data of the patterns;
selecting at least one alignment pattern from among the patterns formed on the semiconductor wafer as the inputted CAD data;
acquiring an alignment pattern image by imaging the selected alignment pattern with the SEM; and
calculating the alignment coordinate system by calculating a position of the selected alignment pattern on the semiconductor wafer on the basis of the acquired alignment pattern image and the CAD data of the alignment pattern on the semiconductor wafer.

10. The method for reviewing a defect by use of the reviewing apparatus equipped with the SEM according to claim 9, wherein:
the step of inputting information about the point-of-interest group further includes the step of inputting a point-of-interest group to be subjected to detailed inspection or review, which is set to the CAD data;
the step of selecting the defect candidates to be subjected to the detailed inspection or review further includes the step of selecting a defect to be subjected to the detailed inspection or review in response to the distance between the positional information of the plural defect candidates on the semiconductor wafer, which has been corrected in the step of correcting the positional information of the plural defect candidates, and the point-of-interest group which is set to the CAD data, the point-of-interest group having been inputted in the step of inputting information.

11. A method for inspecting a defect by use of a reviewing apparatus equipped with a SEM, the method comprising the steps of:
inputting positional information of plural defect candidates on a semiconductor wafer, which are acquired by inspecting the semiconductor wafer by use of an inspection apparatus, and inputting a detailed inspection point candidate on the semiconductor wafer;
analyzing a distribution pattern of defects on the semiconductor wafer on the basis of the positional information of the inputted plural defect candidates on the semiconductor wafer;
determining a detailed inspection point on the semiconductor wafer on the basis of the inputted detailed inspection point candidate on the semiconductor wafer, and the distribution pattern of the defects on the semiconductor wafer; which is acquired in the step of analyzing the distribution pattern of the defects;
acquiring a SEM image of the detailed inspection point by setting a visual field of the SEM with respect to the determined detailed inspection point on the semiconductor wafer; and
inspecting the detailed inspection point by processing the acquired SEM image.

12. The method for inspecting a defect by use of the reviewing apparatus equipped with the SEM according to claim 11, wherein:
the step of performing the inspection further includes the step of measuring the size of a pattern on the semiconductor wafer at a specified detailed inspection point that is set with respect to the SEM image, and then making an analysis by comparing the measured size with sizes of the other same patterns.

13. The method for inspecting a defect by use of the reviewing apparatus equipped with the SEM according to claim 11, wherein:
the step of performing the inspection further includes the step of measuring the lightness of the pattern at the specified position with respect to the SEM image, and then making an analysis by comparing the measured lightness with lightness values of the other same patterns.

14. A reviewing apparatus equipped with a SEM, the reviewing apparatus comprising:
an input unit which inputs positional information of plural defect candidates on a semiconductor wafer, which have been acquired by inspecting the semiconductor wafer by an inspection apparatus, and inputs CAD data of patterns formed on the semiconductor wafer;
a defect candidate position calculation unit which calculates positional information on the inputted CAD data corresponding to the inputted positional information of the plural defect candidates on the semiconductor wafer, which have been inputted by the input unit;
a defect selection unit which selects a defect candidate to be subjected to detailed inspection or review on the basis of the positional information of the plural defect candidates on the CAD data calculated by the defect candidate position calculation unit; and
a SEM image acquiring unit which acquires a SEM image of the selected defect candidate by imaging the selected defect candidate selected by the defect selection unit.

15. The reviewing apparatus equipped with the SEM according to claim 14, wherein:
the input unit further inputs a point-of-interest group to be subjected to detailed inspection or review, which is set to the inputted CAD data; and
the defect selection unit further selects a defect to be subjected to the detailed inspection or review in response to a distance between the positional information of the plural defect candidates on the CAD data, which have been calculated by the defect candidate position calculation unit, and the point-of-interest group set to the CAD data, which have been inputted by the input unit.

16. A reviewing apparatus equipped with a SEM, the reviewing apparatus comprising:
a SEM image acquiring unit which acquires a SEM image of a sample by irradiating the sample with a focused electron beam to scan the sample, and by detecting a secondary electron or a backscattered electron, which is emitted from the sample;
an alignment coordinate system calculation unit which calculates an alignment coordinate system by calculating a position on a semiconductor wafer on the basis of positional information of an alignment pattern acquired from CAD data;
a position calculation unit which calculates positions of selected defect candidates in the calculated alignment coordinate system by processing an image acquired by imaging with the SEM image acquiring unit about the selected defect candidates selected from among plural defect candidates whose positional information on the semiconductor wafer are known;
an error calculation unit which calculates relationship of error between the positional information of the selected defect candidates on the semiconductor wafer and the calculated positions of the selected defect candidates in the calculated alignment coordinate system;
a defect positional information correction unit which corrects the positional information of the plural defect candidates whose positional information on the semiconductor wafer are known, on the basis of the calculated relationship of the error calculated by the error calculation unit;
a defect selection unit which selects defect candidates to be subjected to detailed inspection or review on the basis of the corrected positional information of the plural defect candidates on the semiconductor wafer corrected by the defect positional information correction unit; and
an image processing unit which performs the detailed inspection or review of the selected defect candidates by processing the SEM image that has been acquired with the SEM image acquiring unit about the selected defect candidates.

17. The reviewing apparatus equipped with the SEM according to claim 16, the alignment coordinate system calculation unit further comprising:
an input unit which inputs information including: the positional information of the plural defect candidates on the semiconductor wafer, which are acquired by inspecting the semiconductor wafer with an inspection apparatus; CAD data of patterns formed on the semiconductor wafer; and information about a point-of-interest group to be subjected to detailed inspection or review, which is set to the CAD data;
an alignment pattern selection unit which selects at least one alignment pattern from among the patterns formed on the semiconductor wafer as the inputted CAD data inputted from the input unit; and
an alignment coordinate system calculation unit which calculates the alignment coordinate system by calculating a position of the selected alignment pattern on the semiconductor wafer on the basis of an alignment pattern image acquired by imaging with the SEM image acquiring unit and the CAD data of the alignment pattern on the semiconductor wafer, the selected alignment pattern being selected by alignment pattern selection unit.

18. A reviewing apparatus equipped with a SEM, the reviewing apparatus comprising:
a SEM image acquiring unit which acquires a SEM image of a sample by irradiating the sample with a focused electron beam to scan the sample, and by detecting a secondary electron or a backscattered electron, which is emitted from the sample;
an input unit which inputs positional information of plural defect candidates on a semiconductor wafer, which are acquired by inspecting the semiconductor wafer by use of an inspection apparatus, and inputs a detailed inspection point candidate on the semiconductor wafer;
a distribution pattern analyzing unit which analyzes a distribution pattern of defects on the semiconductor wafer on the basis of the positional information of the inputted plural defect candidates on the semiconductor wafer inputted by the input unit;
a detailed inspection point determination unit which determines a detailed inspection point on the semiconductor wafer on the basis of the inputted detailed inspection point candidate on the semiconductor wafer inputted by the input unit and the distribution pattern of the defects on the semiconductor wafer analyzed by the distribution pattern analyzing unit;
a SEM image visual field setting unit which acquires a SEM image of the detailed inspection point by setting a visual field of the SEM image acquiring unit with respect to the determined detailed inspection point on the semiconductor wafer determined by the detailed inspection point determination unit; and
an image processing unit which inspects the detailed inspection point by processing the SEM image acquired with the visual field set by the SEM image visual field setting unit.

19. The reviewing apparatus equipped with the SEM according to claim 18, wherein:
the image processing unit measures the size of a pattern on the semiconductor wafer at a specified detailed inspection point that is set with respect to the SEM image, and then makes an analysis by comparing the measured size with sizes of the other same patterns.

20. The reviewing apparatus equipped with the SEM according to claim 18, wherein:
the image processing unit measures the lightness of the pattern at the specified position with respect to the SEM image acquired by the SEM image acquiring unit, and compares the measured lightness with lightness values of the other same patterns.
